(19) United States
(12) Patent Application Publication
(10) Pub. No.: US 2015/0378134 A1
(43) Pub. Date: Dec. 31, 2015

(54) ZOOM LENS SYSTEM

(71) Applicant: RICOH IMAGING COMPANY, LTD., Tokyo (JP)

(72) Inventor: Tomoya KOGA, Saitama (JP)

(73) Assignee: RICOH IMAGING COMPANY, LTD., Tokyo (JP)

(21) Appl. No.: 14/767,972

(22) PCT Filed: Feb. 20, 2014
(86) PCT No.: PCT/JP2014/053964

§ 371 Date: Aug. 14, 2015

(30) Foreign Application Priority Data
Feb. 26, 2013 (JP) 2013-035262

(51) Int. Cl. G02B 13/14; G02B 15/17; G02B 13/00; G02B 5/18; G02B 27/42

(52) U.S. Cl. CPC G02B 13/146; G02B 5/1814; G02B 27/4211; G02B 13/009; G02B 13/006; G02B 13/008; G02B 15/17

(57) ABSTRACT

A zoom lens system includes a positive first lens group and a negative second lens group. The first lens group includes a cemented lens, a diffraction surface having a rotationally symmetric shape satisfying condition (1) formed on a cemented surface of the cemented lens, and condition (2) is satisfied:

130<|fD/RD|<10,000(fD>0) (1),

and

0.15<f1/fT<0.35 (2).

fD designates the focal length of the diffraction surface; fD=−1/(2×P2×λ0); P2 designates a secondary coefficient of an optical path difference function for calculating an optical path length addition amount of the diffraction surface, λ0 designates the d-line, RD designates the radius of curvature of the substrate surface having the diffraction surface and fT designates the focal lengths of the entire lens system at the long focal length extremity.

### TECHNICAL FIELD

The present invention relates to a zoom lens system for use in, e.g., a day-and-night surveillance lens system (day-and-night lens).

### BACKGROUND ART

In recent years there has been a demand for zoom lens systems to be more compact (miniaturized), and to have a higher zoom ratio, especially when the focal length is zoomed out to a long focal length for telescopic surveillance. Furthermore, a day-and-night surveillance lens system has been in demand for surveillance use in which the imaging-plane position does not shift from the visible region to the near infra-red region. In order to meet the latter demand, the wavelength range for correcting axial chromatic aberration must be broadened to the near infra-red region, however, the longer the focal length is zoomed out to, the greater the amount of chromatic aberration, which is difficult to favorably correct.

Using an anomalous dispersion glass element is known to be effective for correcting chromatic aberration, especially chromatic aberration in the secondary spectrum; however, since the refractive index of anomalous dispersion glass is low, in order to correct chromatic aberration without deterioration in the suppression of the various aberrations, a large number of lens elements are required, thereby increasing the overall length of the lens system.

On the other hand, correcting chromatic aberration using a diffraction optical element is known. For example, Patent Literature Nos. 1 through 7 disclose providing a diffraction optical element in a positive powered first lens group of a zoom lens system configured of a positive lens group, a negative lens group, a negative lens group and a positive lens group (four lens groups), a zoom lens system configured of a positive lens group, a negative lens group, a positive lens group and a positive lens group (four lens groups), or a zoom lens system configured of a positive lens group, a negative lens group, a positive lens group, a negative lens group and a positive lens group (five lens groups).

However, all of the zoom lens systems in Patent Literature Nos. 1 through 7 have technical problems, such as having an excessive number of lens elements, thereby increasing the overall length of the lens system; the focal length at the long focal-length side being too small, so that the zoom ratio is insufficient for a telephoto lens system; and it being difficult to correct chromatic aberration over the entire zooming range from the visible region to the near infra-red region; so that the optical quality of these zoom lens systems is insufficient for use in a day-and-night surveillance lens system. Furthermore, if a diffraction optical element is provided, unless the diffraction surface is provided at an appropriate position, the optical power is controlled and an appropriate glass material is chosen, it becomes difficult to favorably correct chromatic aberration from the visible region through to a near infra-red region without deterioration in the suppression of various aberrations.

### CITATION LIST

### Patent Literature

Patent Literature 1: Japanese Patent No. 4,928,297

Patent Literature 2: Japanese Unexamined Patent Publication No. 2003-287678

Patent Literature 3: Japanese Unexamined Patent Publication No. 2000-221402

Patent Literature 4: Japanese Unexamined Patent Publication No. 2004-126396

Patent Literature 5: Japanese Unexamined Patent Publication No. 2000-121821

Patent Literature 6: Japanese Patent No. 4,182,088

Patent Literature 7: Japanese Patent No. 4,764,051

### SUMMARY OF INVENTION

### Technical Problem

The present invention has been devised in view of the above-described problems and an object of the present invention is to achieve a zoom lens system, which is suitable for use in a day-and-night surveillance lens system, having a short overall length, the focal length at the long focal-length side is increased to attain a high zoom ratio, and which can achieve a superior optical quality by favorably correcting chromatic aberration over the entire zooming range from the visible region to the near infra-red region.

### Solution to Problem

In an embodiment of a zoom lens system according to the present invention, a zoom lens system is provided, including at least a positive first lens group and a negative second lens group, in that order from the object side, wherein a distance between the first lens group and the second lens group increases while zooming from the short focal length extremity to the long focal length extremity. The first lens group includes at least one cemented lens, a diffraction surface having a rotationally symmetric shape with respect to the optical axis and satisfying the following condition (1) is formed on a cemented surface of at least one of the cemented lens, and the following condition (2) is satisfied:

130<|fD/RD|<10,000(fD>0) (1),

and

0.15<f1/fT<0.35 (2),

wherein fD designates the focal length of the diffraction surface that is formed on the cemented surface of the cemented lens, provided within the first lens group; fD=−1/(2×P2×λ0); P2 designates a secondary coefficient of an optical path difference function for calculating an optical path length addition amount of the diffraction surface that is formed on the cemented surface of the cemented lens, provided within the first lens group, λ0 designates a wavelength for calculating the focal length of the diffraction surface that is formed on the cemented surface of the cemented lens, provided within the first lens group, RD designates the radius of curvature of the substrate surface having the diffraction surface that is formed on the cemented surface of the cemented lens, provided within the first lens group, f1 designates the focal length of the first lens group, and fT designates the focal length of the entire lens system at the long focal length extremity.

In the zoom lens system of the present invention, it is desirable for the first lens group to include at least one negative lens element and for the following conditions (3) and (4) to be satisfied:

νn1>33 (3),

and

θgFn1<0.59 (4),

wherein νn1 designates the Abbe number at the d-line of the at least one negative lens element of negative lens elements that are provided in the first lens group, and θgFn1 designates the partial dispersion ratio of the at least one negative lens element of negative lens elements that are provided in the first lens group.

In another embodiment of the zoom lens system of the present invention, a zoom lens system is provided, including at least a positive first lens group and a negative second lens group, in that order from the object side, wherein, while zooming from the short focal length extremity to the long focal length extremity, the first lens group remains stationary relative to the imaging plane, and a distance between the first lens group and the second lens group increases by the second lens group moving toward the image side. The first lens group includes at least one cemented lens, a diffraction surface having a rotationally symmetric shape with respect to the optical axis and satisfying the following condition (1) is formed on a cemented surface of at least one of the cemented lens, the first lens group includes at least one negative lens element, and the following conditions (3) and (4) are satisfied:

130<|fD/RD|<10,000(fD>0) (1),

νn1>33 (3),

and

θgFn1<0.59 (4),

wherein fD designates the focal length of the diffraction surface that is formed on the cemented surface of the cemented lens, provided within the first lens group; fD=−1/(2×P2×λ0); P2 designates a secondary coefficient of an optical path difference function for calculating an optical path length addition amount of the diffraction surface that is formed on the cemented surface of the cemented lens, provided within the first lens group, λ0 designates a wavelength for calculating the focal length of the diffraction surface that is formed on the cemented surface of the cemented lens, provided within the first lens group, RD designates the radius of curvature of the substrate surface having the diffraction surface that is formed on the cemented surface of the cemented lens, provided within the first lens group, νn1 designates the Abbe number at the d-line of the at least one negative lens element of negative lens elements that are provided in the first lens group, and θgFn1 designates the partial dispersion ratio of the at least one negative lens element of negative lens elements that are provided in the first lens group.

In the zoom lens system of the present invention, it is desirable for the following condition (2) to be satisfied:

0.15<f1/fT<0.35 (2),

wherein f1 designates the focal length of the first lens group, and fT designates the focal length of the entire lens system at the long focal length extremity.

In the zoom lens system of the present invention, it is desirable for the first lens group to include at least one positive lens element, and for the following condition (5) to be satisfied:

νp1>71 (5),

wherein νp1 designates the Abbe number at the d-line of the at least one positive lens element provided within the first lens group.

In the zoom lens system of the present invention, it is desirable for the following condition (6) to be satisfied:

2.9<f1/1gD<6.5 (6),

wherein f1 designates the focal length of the first lens group, and 1gD designates the distance from the surface closest to the object side on the first lens group to the surface closest to the image side on the first lens group (the thickness of the first lens group).

It is desirable for each lens element of the cemented lens that is provided within the first lens group to include a resin material on an opposing substrate glass, wherein a diffraction surface is formed on a boundary surface between the resin materials.

In the zoom lens system of the present invention, it is desirable for the second lens group to include at least one positive lens element, and for the following condition (7) to be satisfied:

νp2<23 (7),

wherein νp2 designates the Abbe number at the d-line of the at least one positive lens element provided within the second lens group.

In the zoom lens system of the present invention, it is desirable for the following condition (8) to be satisfied:

−0.8<f2/(fW×fT)^{1/2}<−0.2 (8),

wherein f2 designates the focal length of the second lens group, fW designates the focal length of the entire lens system at the short focal length extremity, and fT designates the focal length of the entire lens system at the long focal length extremity.

It is desirable for the zoom lens system of the present invention to further include a positive or negative stationary lens group, at a position closest to the image side, which is stationary relative to the imaging plane during zooming from the short focal length extremity to the long focal length extremity, wherein the following condition (9) is satisfied:

|mL|<1.2 (9),

wherein mL designates the lateral magnification of the stationary lens group that is positioned closest to the image side.

It is desirable for the zoom lens system of the present invention to further include a positive or negative stationary lens group, at a position closest to the image side, which is stationary relative to the imaging plane during zooming from the short focal length extremity to the long focal length extremity, wherein the stationary lens group includes at least one positive lens element, and wherein the following condition (10) is satisfied:

νpL>71 (10),

wherein νpL designates the Abbe number at the d-line of the at least one positive lens element provided within the stationary lens group that is positioned closest to the image side.

It is desirable for the zoom lens system of the present invention to further include a negative third lens group, behind the second lens group, which moves during zooming from the short focal length extremity to the long focal length extremity, wherein the following condition (11) is satisfied:

0.9<f2/f3<2.5 (11),

wherein f2 designates the focal length of the second lens group, and f3 designates the focal length of the third lens group

In the zoom lens system of the present invention, a negative third lens group and a positive fourth lens group can be provided behind the second lens group.

In such a case, the second lens group can include a negative lens element, and a cemented lens provided with a positive lens element and a negative lens element, in that order from the object side.

The zoom lens system of the present invention can be further provided, behind the second lens group, with a positive third lens group and a negative fourth lens group.

The zoom lens system of the present invention can be further provided, behind the second lens group, with a positive third lens group, a negative fourth lens group, and a positive fifth lens group.

In another embodiment of the present invention, a zoom lens system is provided, including at least a positive first lens group and a negative second lens group, in that order from the object side, wherein, while zooming from the short focal length extremity to the long focal length extremity, the first lens group remains stationary relative to the imaging plane, and a distance between the first lens group and the second lens group increases by the second lens group moving toward the image side. The first lens group includes at least one cemented lens, a diffraction surface having a rotationally symmetric shape with respect to the optical axis and satisfying the following condition (1) is formed on a cemented surface of at least one of the cemented lens, the first lens group includes at least one positive lens element, and the following condition (5) is satisfied:

130<|fD/RD|<10,000(fD>0) (1),

and

νp1>71 (5),

wherein fD designates the focal length of the diffraction surface that is formed on the cemented surface of the cemented lens, provided within the first lens group; fD=−1/(2×P2×λ0); P2 designates a secondary coefficient of an optical path difference function for calculating an optical path length addition amount of the diffraction surface that is formed on the cemented surface of the cemented lens, provided within the first lens group, λ0 designates a wavelength for calculating the focal length of the diffraction surface that is formed on the cemented surface of the cemented lens, provided within the first lens group, RD designates the radius of curvature of the substrate surface having the diffraction surface that is formed on the cemented surface of the cemented lens, provided within the first lens group, and νp1 designates the Abbe number at the d-line of the at least one positive lens element provided within the first lens group.

In another embodiment of the present invention, a zoom lens system is provided, including at least a positive first lens group and a negative second lens group, in that order from the object side, wherein, while zooming from the short focal length extremity to the long focal length extremity, the first lens group remains stationary relative to the imaging plane and a distance between the first lens group and the second lens group increases by the second lens group moving toward the image side. The first lens group includes at least one cemented lens, a diffraction surface having a rotationally symmetric shape with respect to the optical axis and satisfying the following condition (1) is formed on a cemented surface of at least one of the cemented lens, the second lens group includes at least one positive lens element, and the following condition (7) is satisfied:

130<|fD/RD|<10,000(fD>0) (1),

and

νp2<23 (7),

wherein fD designates the focal length of the diffraction surface that is formed on the cemented surface of the cemented lens, provided within the first lens group; fD=−1/(2×P2×λ0); P2 designates a secondary coefficient of an optical path difference function for calculating an optical path length addition amount of the diffraction surface that is formed on the cemented surface of the cemented lens, provided within the first lens group, λ0 designates a wavelength for calculating the focal length of the diffraction surface that is formed on the cemented surface of the cemented lens, provided within the first lens group, RD designates the radius of curvature of the substrate surface having the diffraction surface that is formed on the cemented surface of the cemented lens, provided within the first lens group, and νp2 designates the Abbe number at the d-line of the at least one positive lens element provided within the second lens group.

In another embodiment of the present invention, a zoom lens system is provided, including at least a positive first lens group, a negative second lens group and a negative third lens group, in that order from the object side, wherein, while zooming from the short focal length extremity to the long focal length extremity, the first lens group remains stationary relative to the imaging plane, and a distance between the first lens group and the second lens group increases by the second lens group moving toward the image side. The first lens group includes at least one cemented lens, a diffraction surface having a rotationally symmetric shape with respect to the optical axis and satisfying the following condition (1) is formed on a cemented surface of at least one of the cemented lens, and the following condition (11) is satisfied:

130<|fD/RD|<10,000(fD>0) (1),

and

0.9<f2/f3<2.5 (11),

wherein fD designates the focal length of the diffraction surface that is formed on the cemented surface of the cemented lens, provided within the first lens group; fD=−1/(2×P2×λ0); P2 designates a secondary coefficient of an optical path difference function for calculating an optical path length addition amount of the diffraction surface that is formed on the cemented surface of the cemented lens, provided within the first lens group, λ0 designates a wavelength for calculating the focal length of the diffraction surface that is formed on the cemented surface of the cemented lens, provided within the first lens group, RD designates the radius of curvature of the substrate surface having the diffraction surface that is formed on the cemented surface of the cemented lens, provided within the first lens group, f2 designates the focal length of the second lens group, and f3 designates the focal length of the third lens group.

In another embodiment of the present invention, a zoom lens system is provided, including at least a positive first lens group and a negative second lens group, in that order from the object side, wherein, while zooming from the short focal length extremity to the long focal length extremity, the first lens group remains stationary relative to the imaging plane, and a distance between the first lens group and the second lens group increases by the second lens group moving toward the image side. The first lens group includes at least one cemented lens, a diffraction surface having a rotationally symmetric shape with respect to the optical axis and satisfying the following condition (1) is formed on a cemented surface of at least one of the cemented lens, and an angle between each principal ray, which is incident on the diffraction surface formed on the cemented surface of the cemented lens of the first lens group, and the optical axis is 13° or less:

130<|fD/RD|<10,000(fD>0) (1),

wherein fD designates the focal length of the diffraction surface that is formed on the cemented surface of the cemented lens, provided within the first lens group; fD=−1/(2×P2×λ0); P2 designates a secondary coefficient of an optical path difference function for calculating an optical path length addition amount of the diffraction surface that is formed on the cemented surface of the cemented lens, provided within the first lens group, λ0 designates a wavelength for calculating the focal length of the diffraction surface that is formed on the cemented surface of the cemented lens, provided within the first lens group, and RD designates the radius of curvature of the substrate surface having the diffraction surface that is formed on the cemented surface of the cemented lens, provided within the first lens group.

In another embodiment of the present invention, a zoom lens system is provided, including at least a positive first lens group and a negative second lens group, in that order from the object side, wherein a distance between the first lens group and the second lens group increases while zooming from the short focal length extremity to the long focal length extremity. The first lens group includes at least one cemented lens, a diffraction surface having a rotationally symmetric shape with respect to the optical axis and satisfying the following condition (12) is formed on a cemented surface of at least one of the cemented lens, and the following condition (2) is satisfied:

0.15<f1/fT<0.35 (2),

and

130<fD/f1(fD>0) (12),

wherein f1 designates the focal length of the first lens group, fT designates the focal length of the entire lens system at the long focal length extremity, fD designates the focal length of the diffraction surface that is formed on the cemented surface of the cemented lens, provided within the first lens group; fD=−1/(2×P2×λ0); P2 designates a secondary coefficient of an optical path difference function for calculating an optical path length addition amount of the diffraction surface that is formed on the cemented surface of the cemented lens, provided within the first lens group, and λ0 designates a wavelength for calculating the focal length of the diffraction surface that is formed on the cemented surface of the cemented lens, provided within the first lens group.

In another embodiment of the present invention, a zoom lens system is provided, including at least a positive first lens group, a negative second lens group and a negative third lens group, in that order from the object side, wherein, while zooming from the short focal length extremity to the long focal length extremity, the first lens group remains stationary relative to the imaging plane, and a distance between the first lens group and the second lens group increases by the second lens group moving toward the image side. The first lens group includes at least one cemented lens, a diffraction surface having a rotationally symmetric shape with respect to the optical axis and satisfying the following condition (12) is formed on a cemented surface of at least one of the cemented lens, and the following condition (11) is satisfied:

0.9<f2/f3<2.5 (11),

and

130<fD/f1(fD>0) (12),

wherein f2 designates the focal length of the second lens group, f3 designates the focal length of the third lens group, fD designates the focal length of the diffraction surface that is formed on the cemented surface of the cemented lens, provided within the first lens group; fD=−1/(2×P2×λ0); P2 designates a secondary coefficient of an optical path difference function for calculating an optical path length addition amount of the diffraction surface that is formed on the cemented surface of the cemented lens, provided within the first lens group, and λ0 designates a wavelength for calculating the focal length of the diffraction surface that is formed on the cemented surface of the cemented lens, provided within the first lens group.

It is desirable for the zoom lens system of the present invention to satisfy the following condition (1′) within the scope of condition (1):

200<|fD/RD|<10,000(fD>0) (1′).

It is desirable for the zoom lens system of the present invention to satisfy the following condition (12′) within the scope of condition (12):

130<fD/f1<10,000(fD>0) (12′).

It is desirable for the zoom lens system of the present invention to satisfy the following condition (2′):

0.14<f1/fT<0.31 (2′).

It is desirable for the zoom lens system of the present invention to satisfy the following condition (12″) within the scope of condition (12):

190<fD/f1<10,000(fD>0) (12″).

It is desirable for the zoom lens system of the present invention to include at least one positive lens element in the first lens group, and to satisfy condition (5) while simultaneously satisfying the following condition (13):

θgFp1−(−5.0×10⁻⁴×νp1+0.5700)>0 (13),

wherein θgFp1 designates the partial dispersion ratio of at least one positive lens element of the positive lens elements that are provided in the first lens group, and νp1 designates the Abbe number at the d-line of the at least one positive lens element of the positive lens elements that are provided in the first lens group.

It is desirable for the zoom lens system of the present invention to include at least one positive lens element in the second lens group, and to satisfy condition (7) while simultaneously satisfying the following condition (14):

θgFp2−(−1.0×10⁻⁴×νp2+0.6300)>0 (14),

wherein θgFp2 designates the partial dispersion ratio of at least one positive lens element of the positive lens elements that are provided in the second lens group, and νp2 designates the Abbe number at the d-line of the at least one positive lens element of the positive lens elements that are provided in the second lens group.

It is desirable for the zoom lens system of the present invention to satisfy the following condition (15):

30<fD/fT(fD>0) (15),

wherein

fD designates the focal length of the diffraction surface that is formed on the cemented surface of a cemented lens which is provided within the first lens group, fD=−1/(2×P2×λ0), P2 designates a secondary coefficient of an optical path difference function for calculating an optical path length addition amount of the diffraction surface that is formed on the cemented surface of the cemented lens which is provided within the first lens group, λ0 designates a wavelength for calculating the focal length of the diffraction surface that is formed at the cemented surface of a cemented lens which is provided within the first lens group, and fT designates the focal length of the entire lens system at the long focal length extremity.

It is desirable for the zoom lens system of the present invention to satisfy the following condition (15′) within the scope of condition (15):

30<fD/f1<10,000(fD>0) (15′).

In the zoom lens system of the present invention, it is desirable for the second lens group to include a negative lens element, and a cemented lens configured of a positive lens element and a negative lens element, in that order from the object side, wherein the following condition (16) is satisfied:

−5.0<(L21f+L21r)/(L21f−L21r)<0.9 (16),

wherein

L21f designates the radius of curvature of a surface on the object side of a negative lens element that is provided closest to the object side within the second lens group, and

L21r designates the radius of curvature of a surface on the image side of a negative lens element that is provided closest to the image side within the second lens group.

### Advantageous Effects of Invention

According to the present invention, a zoom lens system can be achieved, which is suitable for use in a day-and-night surveillance lens system, having a short overall length, the focal length at the long focal-length side being increased to attain a high zoom ratio, and which can achieve a superior optical quality by favorably correcting chromatic aberration over the entire zooming range from the visible region to the near infra-red region.

### BRIEF DESCRIPTION OF DRAWINGS

FIG. 1 shows a lens arrangement of a first numerical embodiment of a zoom lens system, according to the present invention, when focused on an object at infinity at the short focal length extremity;

FIG. 2 shows various aberrations that occurred in the zoom lens system shown in FIG. 1 when focused on an object at infinity at the short focal length extremity;

FIG. 3 shows various aberrations that occurred in the zoom lens system shown in FIG. 1 when focused on an object at infinity at an intermediate focal length;

FIG. 4 shows various aberrations that occurred in the zoom lens system shown in FIG. 1 when focused on an object at infinity at the long focal length extremity;

FIG. 5 shows a lens arrangement of a second numerical embodiment of a zoom lens system, according to the present invention, when focused on an object at infinity at the short focal length extremity;

FIG. 6 shows various aberrations that occurred in the zoom lens system shown in FIG. 5 when focused on an object at infinity at the short focal length extremity;

FIG. 7 shows various aberrations that occurred in the zoom lens system shown in FIG. 5 when focused on an object at infinity at an intermediate focal length;

FIG. 8 shows various aberrations that occurred in the zoom lens system shown in FIG. 5 when focused on an object at infinity at the long focal length extremity;

FIG. 9 shows a lens arrangement of a third numerical embodiment of a zoom lens system, according to the present invention, when focused on an object at infinity at the short focal length extremity;

FIG. 10 shows various aberrations that occurred in the zoom lens system shown in FIG. 9 when focused on an object at infinity at the short focal length extremity;

FIG. 11 shows various aberrations that occurred in the zoom lens system shown in FIG. 9 when focused on an object at infinity at an intermediate focal length;

FIG. 12 shows various aberrations that occurred in the zoom lens system shown in FIG. 9 when focused on an object at infinity at the long focal length extremity;

FIG. 13 shows a lens arrangement of a fourth numerical embodiment of a zoom lens system, according to the present invention, when focused on an object at infinity at the short focal length extremity;

FIG. 14 shows various aberrations that occurred in the zoom lens system shown in FIG. 13 when focused on an object at infinity at the short focal length extremity;

FIG. 15 shows various aberrations that occurred in the zoom lens system shown in FIG. 13 when focused on an object at infinity at an intermediate focal length;

FIG. 16 shows various aberrations that occurred in the zoom lens system shown in FIG. 13 when focused on an object at infinity at the long focal length extremity;

FIG. 17 shows a lens arrangement of a fifth numerical embodiment of a zoom lens system, according to the present invention, when focused on an object at infinity at the short focal length extremity;

FIG. 18 shows various aberrations that occurred in the zoom lens system shown in FIG. 17 when focused on an object at infinity at the short focal length extremity;

FIG. 19 shows various aberrations that occurred in the zoom lens system shown in FIG. 17 when focused on an object at infinity at an intermediate focal length;

FIG. 20 shows various aberrations that occurred in the zoom lens system shown in FIG. 17 when focused on an object at infinity at the long focal length extremity;

FIG. 21 shows a lens arrangement of a sixth numerical embodiment of a zoom lens system, according to the present invention, when focused on an object at infinity at the short focal length extremity;

FIG. 22 shows various aberrations that occurred in the zoom lens system shown in FIG. 21 when focused on an object at infinity at the short focal length extremity;

FIG. 23 shows various aberrations that occurred in the zoom lens system shown in FIG. 21 when focused on an object at infinity at an intermediate focal length;

FIG. 24 shows various aberrations that occurred in the zoom lens system shown in FIG. 21 when focused on an object at infinity at the long focal length extremity;

FIG. 25 shows a lens arrangement of a seventh numerical embodiment of a zoom lens system, according to the present invention, when focused on an object at infinity at the short focal length extremity;

FIG. 26 shows various aberrations that occurred in the zoom lens system shown in FIG. 25 when focused on an object at infinity at the short focal length extremity;

FIG. 27 shows various aberrations that occurred in the zoom lens system shown in FIG. 25 when focused on an object at infinity at an intermediate focal length;

FIG. 28 shows various aberrations that occurred in the zoom lens system shown in FIG. 25 when focused on an object at infinity at the long focal length extremity;

FIG. 29 shows a lens arrangement of an eighth numerical embodiment of a zoom lens system, according to the present invention, when focused on an object at infinity at the short focal length extremity;

FIG. 30 shows various aberrations that occurred in the zoom lens system shown in FIG. 29 when focused on an object at infinity at the short focal length extremity;

FIG. 31 shows various aberrations that occurred in the zoom lens system shown in FIG. 29 when focused on an object at infinity at an intermediate focal length;

FIG. 32 shows various aberrations that occurred in the zoom lens system shown in FIG. 29 when focused on an object at infinity at the long focal length extremity;

FIG. 33 shows a lens arrangement of a ninth numerical embodiment of a zoom lens system, according to the present invention, when focused on an object at infinity at the short focal length extremity;

FIG. 34 shows various aberrations that occurred in the zoom lens system shown in FIG. 33 when focused on an object at infinity at the short focal length extremity;

FIG. 35 shows various aberrations that occurred in the zoom lens system shown in FIG. 33 when focused on an object at infinity at an intermediate focal length;

FIG. 36 shows various aberrations that occurred in the zoom lens system shown in FIG. 33 when focused on an object at infinity at the long focal length extremity;

FIG. 37 shows a lens arrangement of a tenth numerical embodiment of a zoom lens system, according to the present invention, when focused on an object at infinity at the short focal length extremity;

FIG. 38 shows various aberrations that occurred in the zoom lens system shown in FIG. 37 when focused on an object at infinity at the short focal length extremity;

FIG. 39 shows various aberrations that occurred in the zoom lens system shown in FIG. 37 when focused on an object at infinity at an intermediate focal length;

FIG. 40 shows various aberrations that occurred in the zoom lens system shown in FIG. 37 when focused on an object at infinity at the long focal length extremity;

FIG. 41 shows a lens arrangement of a Reference Example in which an extender has been inserted into the zoom lens system of FIG. 37;

FIG. 42 shows various aberrations that occurred in the zoom lens system shown in FIG. 41 when focused on an object at infinity at the short focal length extremity;

FIG. 43 shows various aberrations that occurred in the zoom lens system shown in FIG. 41 when focused on an object at infinity at an intermediate focal length;

FIG. 44 shows various aberrations that occurred in the zoom lens system shown in FIG. 41 when focused on an object at infinity at the long focal length extremity;

FIG. 45 shows a first zoom path of the zoom lens system according to the present invention;

FIG. 46 shows a second zoom path of the zoom lens system according to the present invention;

FIG. 47 shows a third zoom path of the zoom lens system according to the present invention;

FIG. 48 shows a fourth zoom path of the zoom lens system according to the present invention;

FIG. 49 shows a schematic view of the structure of the diffraction surface formed on the cemented surface of the cemented lens that is provided within the first lens group;

FIG. 50 is a diagram showing the diffraction efficiency of the diffraction surface, formed on the cemented surface of the cemented lens that is provided within the first lens group, in the case where the diffraction surface incident angle is 0 degrees; and

FIG. 51 is a diagram showing the diffraction efficiency of the diffraction surface, formed on the cemented surface of the cemented lens that is provided within the first lens group, in the case where the diffraction surface incident angle is 13 degrees.

### DESCRIPTION OF EMBODIMENTS

The zoom lens system according to the present invention will be hereinafter discussed with reference to the drawings.

In the present specification, “entire lens system” refers to the optical system until the object-emanated image is formed as a first real image (primary image).

Furthermore, the Abbe number νd and the partial dispersion ratio θgF are as follows:

νd=(nd−1)/(nF−nC),

and

θgF=(ng−nF)/(nF−nC),

wherein ng, nF, nd and nC respectively designate the refractive indexes of the material at the wavelength 435.84 nm (g-line), the wavelength 486.13 nm (F-line), the wavelength 587.56 nm (d-line) and the wavelength 656.27 nm (C-line).

In the first through fifth, ninth and tenth numerical embodiments, the zoom lens system is configured of a positive first lens group G1, a negative second lens group G2, a negative third lens group G3 and a positive fourth lens group G4 (four lens groups constituting a positive-negative-negative-positive lens group configuration of a zoom lens system), in that order from the object side, as shown in the zoom path of FIG. 45. An aperture diaphragm S is positioned between the third lens group G3 and the fourth lens group G4 (immediately in front of the fourth lens group G4). ‘I’ designates the imaging surface.

In the zoom lens system of the first through fifth, ninth and tenth numerical embodiments, during zooming from the short focal length extremity (Wide) to the long focal length extremity (Tele), the distance between the first lens group G1 and the second lens group G2 increases, the distance between the second lens group G2 and the third lens group G3 decreases, and the distance between the third lens group G3 and the fourth lens group G4 decreases.

More specifically, during zooming from the short focal length extremity to the long focal length extremity, the first lens group G1 and the fourth lens group G4 remain stationary relative to the imaging surface I, the second lens group G2 moves toward the image side while plotting a convex path that faces the image side, and the third lens group G3 moves toward the image side while plotting a convex path that faces the object side. Focusing is carried out by moving the first lens group G1 toward the object side.

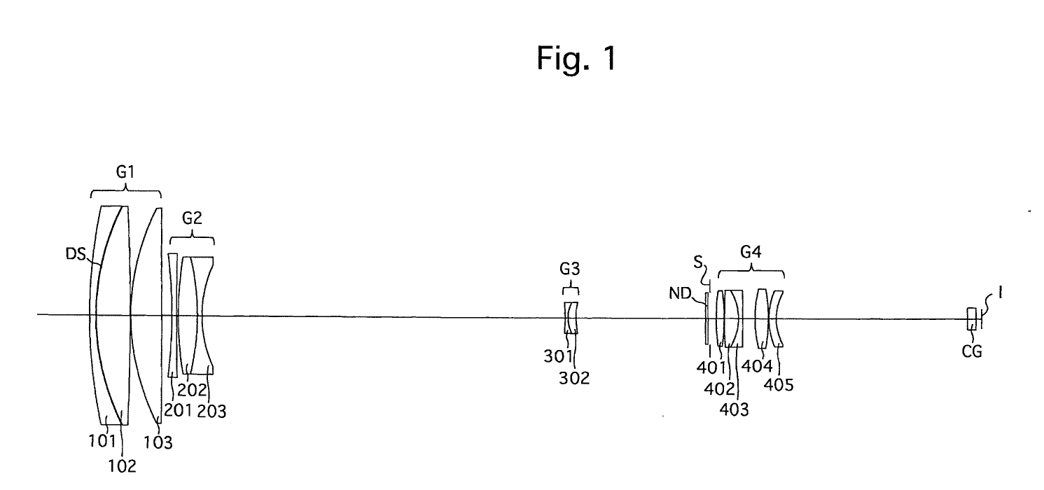

As shown in FIG. 1, in the first numerical embodiment, the first lens group G1 is configured of a negative lens element 101, a positive lens element 102 and a positive lens element 103, in that order from the object side. The surface on the image side of the negative lens element 101 and the surface on the object side of the positive lens element 102 are cemented to each other, and a diffraction surface (diffraction lens surface) DS which is formed on the cemented surface has a rotationally symmetric shape with respect to the optical axis.

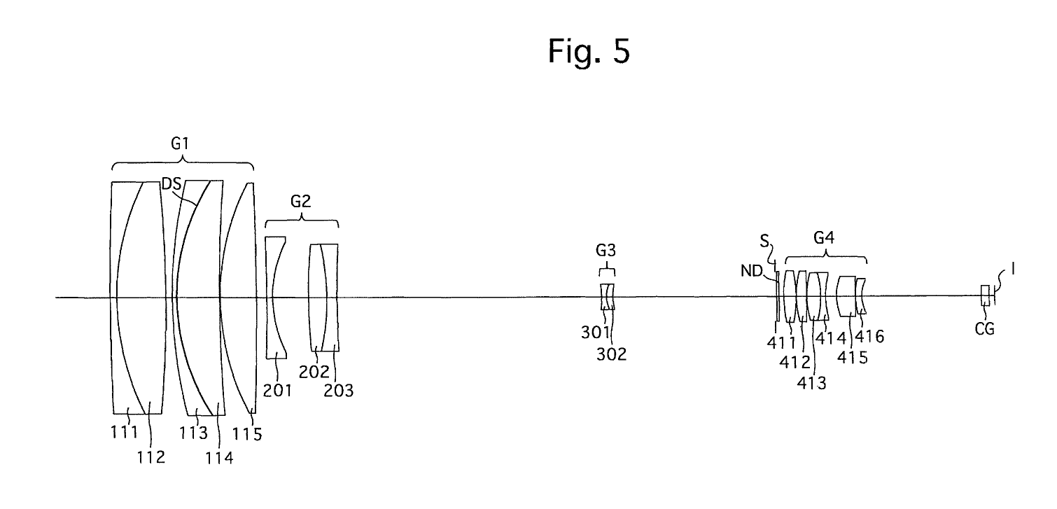

As shown in FIG. 5, in the second numerical embodiment, the first lens group G1 is configured of a negative lens element 111, a positive lens element 112, a negative lens element 113, a positive lens element 114 and a positive lens element 115, in that order from the object side. The surface on the image side of the negative lens element 111 and the surface on the object side of the positive lens element 112 are cemented to each other. The surface on the image side of the negative lens element 113 and the surface on the object side of the positive lens element 114 are cemented to each other, and a diffraction surface DS which has a rotationally symmetric shape with respect to the optical axis is formed on the cemented surface thereof.

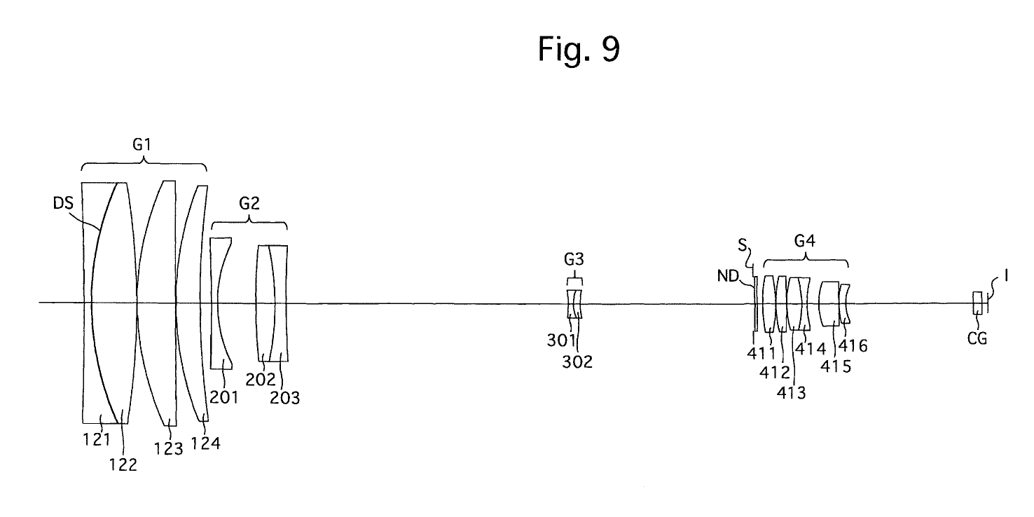

As shown in FIGS. 9, 13, 33 and 37, in the third, fourth, ninth and tenth numerical embodiments, the first lens group G1 is configured of a negative lens element 121, a positive lens element 122, a positive lens element 123, and a positive lens element 124, in that order from the object side. The surface on the image side of the negative lens element 121 and the surface on the object side of the positive lens element 122 are cemented to each other, and a diffraction surface DS which has a rotationally symmetric shape with respect to the optical axis is formed on the cemented surface thereof.

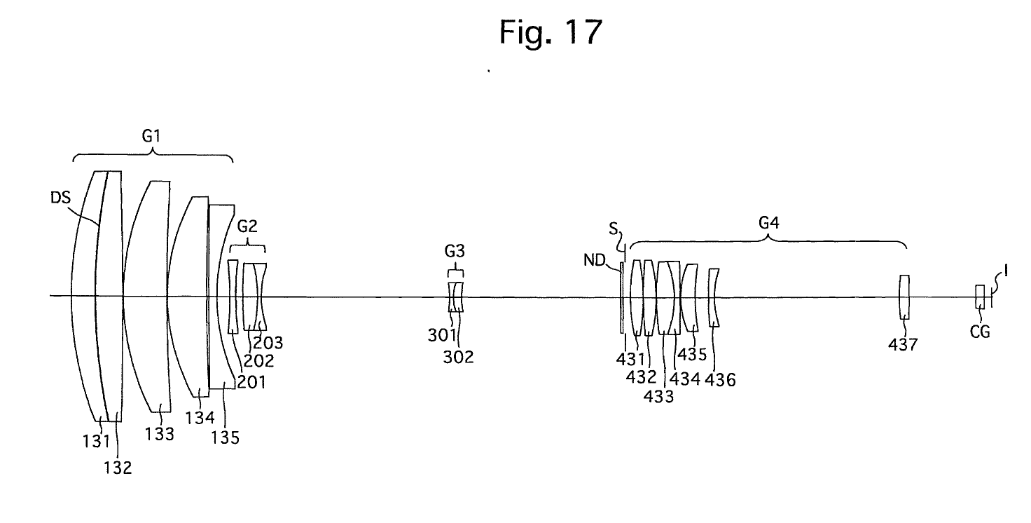

As shown in FIG. 17, in the fifth numerical embodiment, the first lens group G1 is configured of a positive lens element 131, a positive lens element 132, a positive lens element 133, a positive lens element 134 and a negative lens element 135, in that order from the object side. The surface on the image side of the positive lens element 131 and the surface on the object side of the positive lens element 132 are cemented to each other, and a diffraction surface DS which has a rotationally symmetric shape with respect to the optical axis is formed on the cemented surface thereof.

As shown in FIGS. 1, 5, 9, 13, 17, 33 and 37, in the first through fifth, ninth and tenth numerical embodiments, the second lens group G2 is configured of a negative lens element 201, a positive lens element 202 and a negative lens element 203, in that order from the object side. The surface on the image side of the positive lens element 202 and the surface on the object side of the negative lens element 203 are cemented to each other. By configuring the second lens group G2 in such a manner, the number of lens elements of the second lens group G2 can be reduced while facilitating correction of coma throughout the entire zooming range.

As shown in FIGS. 1, 5, 9, 13, 17, 33 and 37, in the first through fifth, ninth and tenth numerical embodiments, the third lens group G3 is configured of a negative lens element 301 and a positive lens element 302, in that order from the object side. The surface on the image side of the negative lens element 301 and the surface on the object side of the positive lens element 302 are cemented to each other.

As shown in FIG. 1, in the first numerical embodiment, the fourth lens group G4 is configured of a positive lens element 401, a positive lens element 402, a negative lens element 403, a positive lens element 404 and a negative lens element 405, in that order from the object side. The surface on the image side of the positive lens element 402 and the surface on the object side of the negative lens element 403 are cemented to each other.

As shown in FIGS. 5, 9 and 37, in the second, third and tenth numerical embodiments, the fourth lens group G4 is configured of a positive lens element 411, a positive lens element 412, a positive lens element 413, a negative lens element 414, a positive lens element 415 and a negative lens element 416, in that order from the object side. The surface on the image side of the positive lens element 413 and the surface on the object side of the negative lens element 414 are cemented to each other.

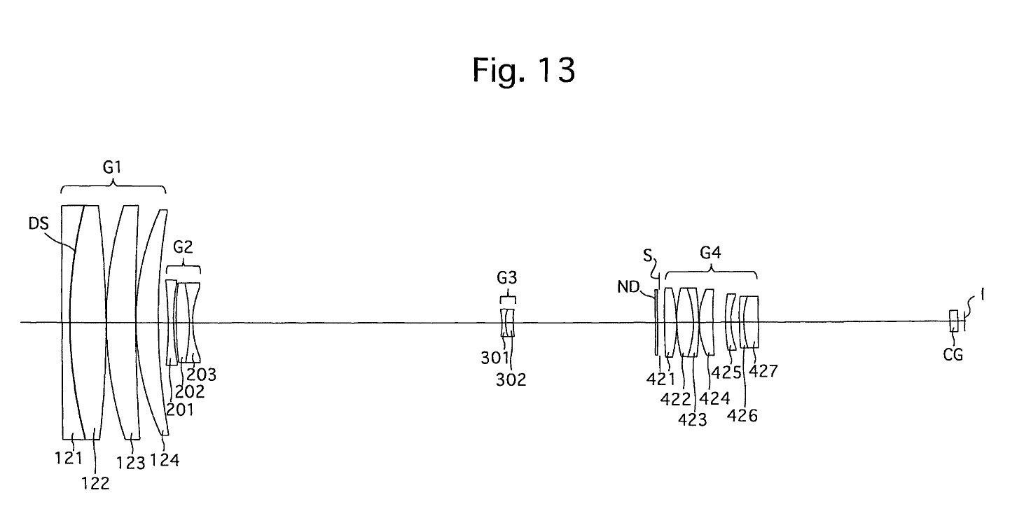

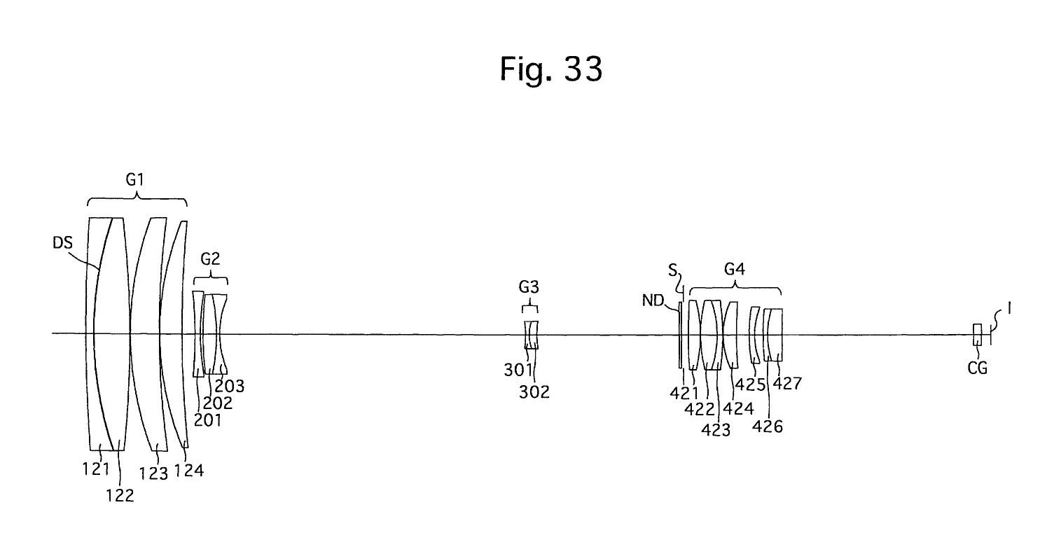

As shown in FIGS. 13 and 33, in the fourth and ninth numerical embodiments, the fourth lens group G4 is configured of a positive lens element 421, a positive lens element 422, a negative lens element 423, a positive lens element 424, a negative lens element 425, a negative lens element 426 and a positive lens element 427, in that order from the object side. The surface on the image side of the positive lens element 422 and the surface on the object side of the negative lens element 423 are cemented to each other. The surface on the image side of the negative lens element 426 and the surface on the object side of the positive lens element 427 are cemented to each other.

As shown in FIG. 17, in the fifth numerical embodiment, the fourth lens group G4 is configured of a positive lens element 431, a positive lens element 432, a positive lens element 433, a negative lens element 434, a positive lens element 435, a negative lens element 436 and a positive lens element 437, in that order from the object side. The surface on the image side of the positive lens element 433 and the surface on the object side of the negative lens element 434 are cemented to each other.

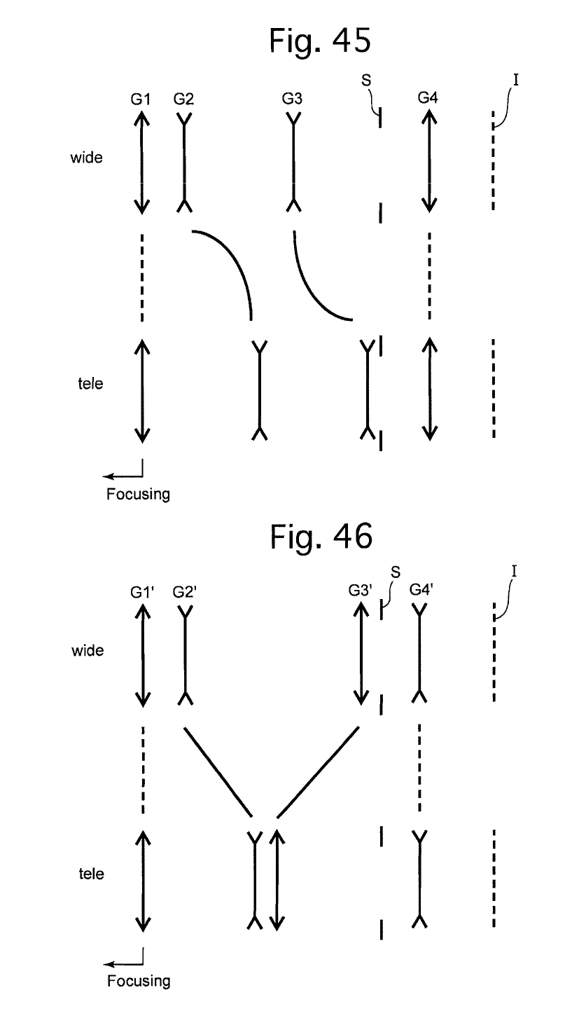

In the sixth numerical embodiment, the zoom lens system is configured of a positive first lens group G1′, a negative second lens group G2′, a positive third lens group G3′ and a negative fourth lens group G4′ (four lens groups constituting a positive-negative-positive-negative lens group configuration of a zoom lens system), in that order from the object side, as shown in the zoom path of FIG. 46. An aperture diaphragm S is positioned between the third lens group G3′ and the fourth lens group G4′ (immediately in front of the fourth lens group G4′). ‘I’ designates the imaging surface.

In the zoom lens system of the sixth numerical embodiment, during zooming from the short focal length extremity (Wide) to the long focal length extremity (Tele), the distance between the first lens group G1′ and the second lens group G2′ increases, the distance between the second lens group G2′ and the third lens group G3′ decreases, and the distance between the third lens group G3′ and the fourth lens group G4′ increases.

More specifically, during zooming from the short focal length extremity to the long focal length extremity, the first lens group G1′ and the fourth lens group G4′ remain stationary relative to the imaging surface I, the second lens group G2′ moves monotonically toward the image side, and the third lens group G3′ moves monotonically toward the object side. Focusing is carried out by moving the first lens group G1′ toward the object side.

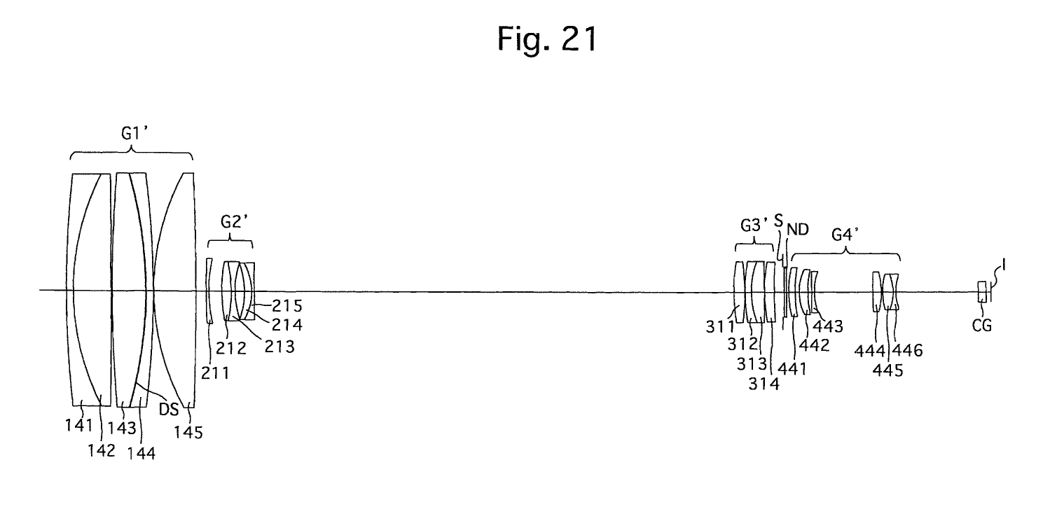

As shown in FIG. 21, the first lens group G1′ is configured of a negative lens element 141, a positive lens element 142, a positive lens element 143, a negative lens element 144 and a positive lens element 145, in that order from the object side. The surface on the image side of the negative lens element 141 and the surface on the object side of the positive lens element 142 are cemented to each other. The surface on the image side of the positive lens element 143 and the surface on the object side of the negative lens element 144 are cemented to each other, and a diffraction surface DS which has a rotationally symmetric shape with respect to the optical axis is formed on the cemented surface thereof.

The second lens group G2′ is configured of a negative lens element 211, a positive lens element 212, a negative lens element 213, a positive lens element 214 and a negative lens element 215, in that order from the object side. The surface on the image side of the positive lens element 212 and the surface on the object side of the negative lens element 213 are cemented to each other. The surface on the image side of the positive lens element 214 and the surface on the object side of the negative lens element 215 are cemented to each other.

The third lens group G3′ is configured of a positive lens element 311, a negative lens element 312, a positive lens element 313 and a positive lens element 314, in that order from the object side. The surface on the image side of the negative lens element 312 and the surface on the object side of the positive lens element 313 are cemented to each other.

The fourth lens group G4′ is configured of a positive lens element 441, a positive lens element 442, a negative lens element 443, a positive lens element 444, a positive lens element 445 and a negative lens element 446, in that order from the object side. The surface on the image side of the positive lens element 445 and the surface on the object side of the negative lens element 446 are cemented to each other.

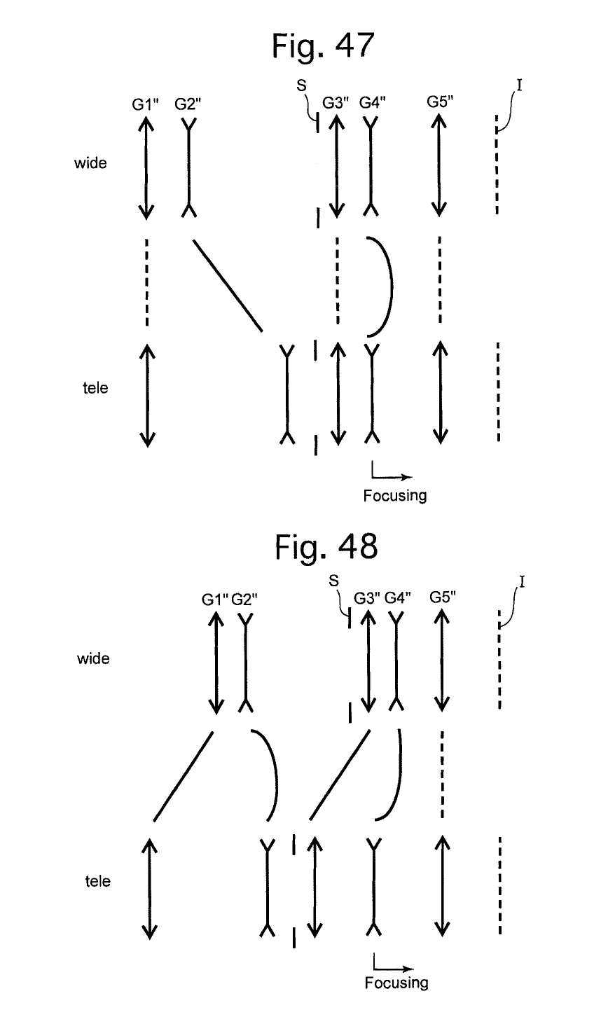

In the seventh and eighth numerical embodiments, the zoom lens system is configured of a positive first lens group G1″, a negative second lens group G2″, a positive third lens group G3″, a negative fourth lens group G4″ and a positive first lens group G5″ (five lens groups constituting a positive-negative-positive-negative-positive lens group configuration of a zoom lens system), in that order from the object side, as shown in the zoom paths of FIGS. 47 and 48. An aperture diaphragm S is positioned between the second lens group G2″ and the third lens group G3″ (immediately in front of the fourth lens group G3″). ‘I’ designates the imaging surface.

In the zoom lens system of the seventh numerical embodiment, during zooming from the short focal length extremity (Wide) to the long focal length extremity (Tele), the distance between the first lens group G1″ and the second lens group G2″ increases, the distance between the second lens group G2″ and the third lens group G3″ decreases, the distance between the third lens group G3″ and the fourth lens group G4″ decreases, and the distance between the fourth lens group G4″ and the fifth lens group G5″ increases, as shown in the zoom path of FIG. 47.

More specifically, during zooming from the short focal length extremity to the long focal length extremity, the first lens group G1″, the third lens group G3″ and the fifth lens group G5″ remain stationary relative to the surface I, the second lens group G2″ moves monotonically toward the image side, and the fourth lens group G4″ first moves toward the image side and thereafter moves toward the object side until exceeding the position thereof when the fourth lens group G4″ was at the short focal length extremity. Focusing is carried out by moving the fourth lens group G4″ toward the image side.

In the zoom lens system of the eighth numerical embodiment, during zooming from the short focal length extremity (Wide) to the long focal length extremity (Tele), the distance between the first lens group G1″ and the second lens group G2″ increases, the distance between the second lens group G2″ and the third lens group G3″ decreases, the distance between the third lens group G3″ and the fourth lens group G4″ increases, and the distance between the fourth lens group G4″ and the fifth lens group G5″ increases, as shown in the zoom path of FIG. 48.

More specifically, during zooming from the short focal length extremity to the long focal length extremity, the fifth lens group G5″ remains stationary relative to the imaging surface I, the first lens group G1″ moves monotonically toward the object side, the second lens group G2″ moves toward the image side while plotting a convex curve that faces the image side, the third lens group G3″ moves monotonically toward the object side, and the fourth lens group G4″ moves toward the object side while plotting a convex curve that faces the image side. Focusing is carried out by moving the fourth lens group G4″ toward the image side.

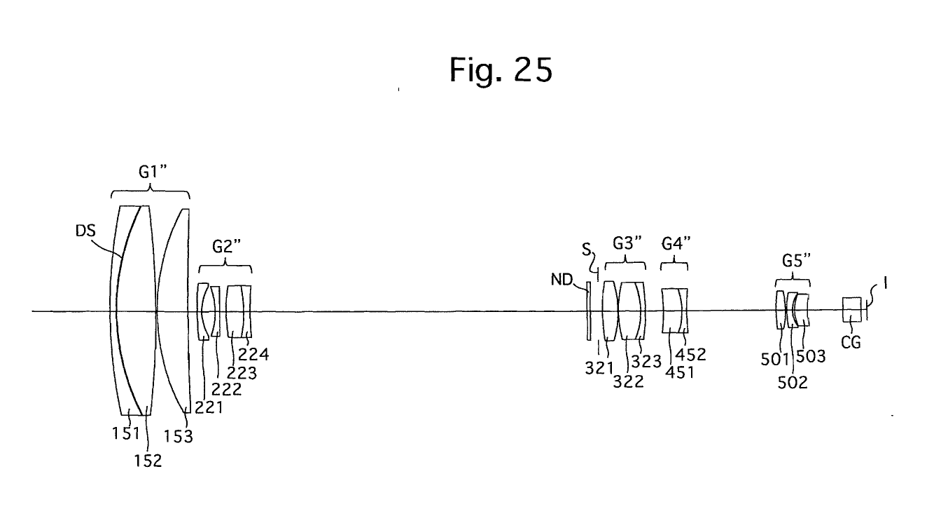

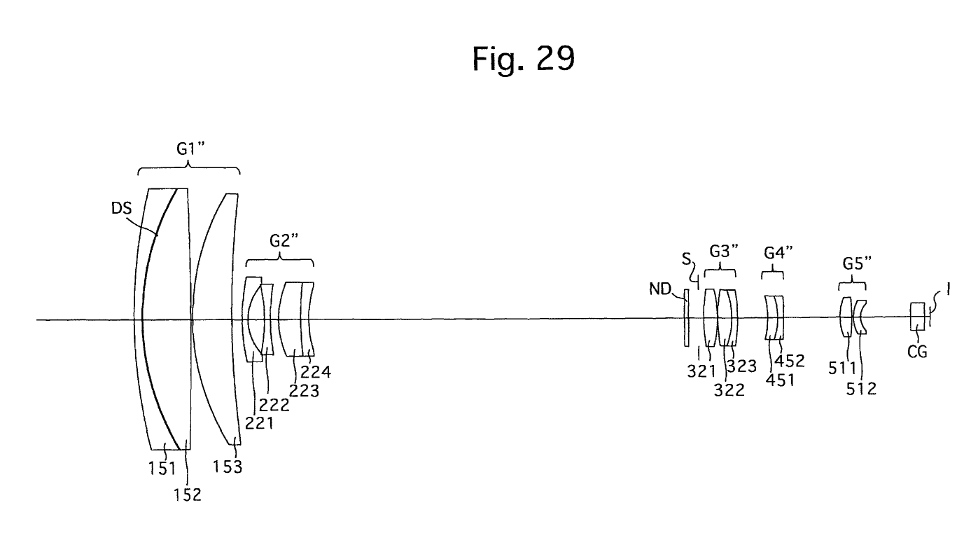

As shown in FIGS. 25 and 29, in the seventh and eighth embodiments, the first lens group G1″ is configured of a negative lens element 151, a positive lens element 152 and a positive lens element 153, in that order from the object side. The surface on the image side of the negative lens element 151 and the surface on the object side of the positive lens element 152 are cemented to each other, and a diffraction surface DS which has a rotationally symmetric shape with respect to the optical axis is formed on the cemented surface thereof.

As shown in FIGS. 25 and 29, in the seventh and eighth embodiments, the second lens group G2″ is configured of a negative lens element 221, a negative lens element 222, a positive lens element 223 and a negative lens element 224, in that order from the object side. The surface on the image side of the positive lens element 223 and the surface on the object side of the negative lens element 224 are cemented to each other.

As shown in FIGS. 25 and 29, in the seventh and eighth embodiments, the third lens group G3″ is configured of a positive lens element 321, a positive lens element 322 and a negative lens element 323, in that order from the object side. The surface on the image side of the positive lens element 322 and the surface on the object side of the negative lens element 323 are cemented to each other.

As shown in FIGS. 25 and 29, in the seventh and eighth embodiments, the fourth lens group G4″ is configured of a positive lens element 451 and a negative lens element 452, in that order from the object side. The surface on the image side of the positive lens element 451 and the surface on the object side of the negative lens element 452 are cemented to each other.

As shown in FIG. 25, in the seventh embodiment, the fifth lens group G5″ is configured of a positive lens element 501, a negative lens element 502 and a positive lens element 503, in that order from the object side.

As shown in FIG. 29, in the eighth embodiment, the fifth lens group G5″ is configured of a positive lens element 511 and a negative lens element 512, in that order from the object side.

The zoom lens system, of the illustrated embodiments, is provided with at least a positive first lens group (G1, G1′ or G1″) and a negative second lens group (G2, G2′ or G2″), in that order from the object side, and by carrying out zooming by increasing the distance between the first lens group and the second lens group, the overall length of the lens system can be shortened and the configuration thereof is advantageous for achieving a high zoom ratio by increasing the focal length at the long focal-length side. Furthermore, by moving a greater number of lens elements within the zoom lens system increases the zooming efficiency, and further miniaturization and a higher zoom ratio become achievable. However, compared to the stationary lens groups that do not move during zooming, decentration easily occurs in the movable lens groups which move during zooming. Generally, in order to widen the angle-of-view of a positive-lead zoom lens system, the lens diameter of the first lens group tends to enlarge and the weight thereof increases, hence, decentration of the first lens group during zooming easily occurs. The decentration of the first lens group has an adverse influence mainly on aberrations at the telephoto side, and becomes a cause of deterioration in the optical quality. Therefore, in the first through seventh, ninth and tenth numerical embodiments of the present invention, in order to eliminate an adverse influences caused by decentration of the first lens group G1, the first lens group G1 is made to remain stationary relative to the imaging surface I during zooming from the short focal length extremity to the long focal length extremity.

In the zoom lens system of the illustrated embodiments, a diffraction surface DS which has a rotationally symmetric shape with respect to the optical axis is formed on the cemented surface of the cemented lens (101 and 102, 113 and 114, 121 and 122, 131 and 132, 143 and 144, or 151 and 152) provided within the first lens group (G1, G1′ or G1″). Furthermore, due to the arrangement of the diffraction surface, by controlling the optical power, and by further selecting an optimum material, a superior optical quality has been successfully achieved in which chromatic aberration has been favorably corrected from the visible region to a near infra-red region over the entire zooming range.

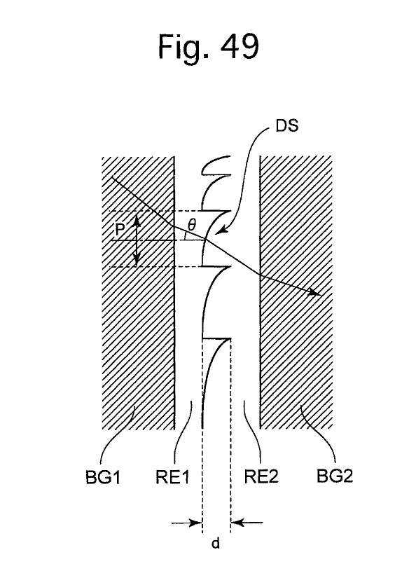

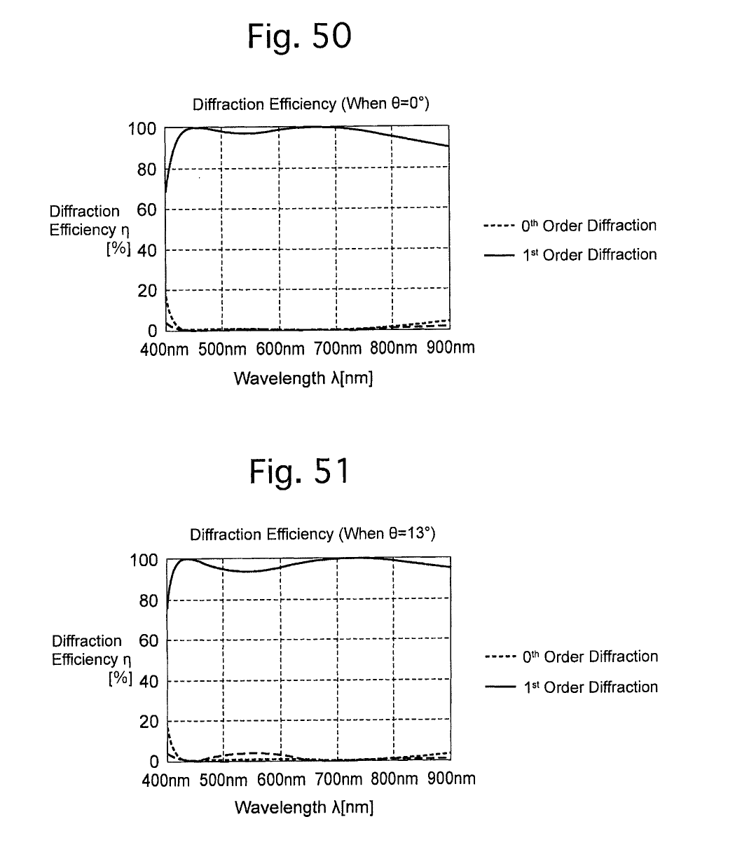

FIG. 49 shows the structure of the diffraction surface DS provided in the first lens group (G1, G1′ or G1″) and FIGS. 50 and 51 show the diffraction efficiency thereof. As shown in FIG. 49, each cemented lens (101 and 102, 113 and 114, 121 and 122, 131 and 132, 143 and 144, or 151 and 152) within the first lens group (G1, G1′ or G1″) is provided with a resin material RE1 on a substrate glass BG1 and a resin material RE2 on a substrate glass BG2, and the diffraction surface DS is formed at the boundary surface between the resin material RE1 and the resin material RE2. When the diffraction optical element is used, the light-quantity deterioration, at the design order, becomes flare due to the influence of the unwanted diffraction order. The ratio of the design-order diffracted light to the unwanted light relative to the total quantity of transmitted light is shown by the diffraction efficiency, and is characterized by being dependent on wavelength. The wavelength dependency of diffraction efficiency can be resolved by laminating two materials that have different refractive indexes and Abbe numbers. Hence, in the illustrated embodiments, the refractive index nd and the Abbe number νd of the resin material RE1 (nd=1.61505, νd=26.5) is made to be different from the refractive index nd and the Abbe number νd of the resin material RE2 (nd=1.64310, νd=38.8) and are cemented to each other; furthermore, in order to achieve a high diffraction efficiency from the visible light region through to the near infra-red region, the optimum wavelength is set to 670 nm and the grating thickness of the diffraction surface DS (the height of the steps in a direction parallel to the optical axis of the diffraction surface DS), indicated as ‘d’ in FIG. 49, is set to 22.4 μm. Furthermore, ‘P’ indicated in FIG. 49 shows the grating pitch of the diffraction surface DS.

The diffraction surface (diffraction lens surface) is shown by a macroscopic profile, indicated by the radius of curvature R, and by an optical path difference function defined by the following equation:

Δø(h)=(P₂h²+P₄h⁴+ . . . )λ, wherein

h designates the height from the optical axis,

Pi designates an optical path difference function coefficient, and

λ designates an arbitrary wavelength.

Furthermore, the focal length fD of paraxial first order light (m=1) at the reference wavelength of the diffraction portion is represented by the following equation with the coefficient of the quadratic term from the previous equation (a), which indicates the phase of the diffraction portion:

fD=−1/(2×P₂×λ₀), wherein

λ₀ designates an arbitrary wavelength for calculating the power of the diffraction surface. In the conditions detailed below, λ₀ is set at the d-line (587.56 nm).

In FIG. 49, ‘θ’ designates the angle between the optical axis and the principal rays, incident onto the diffraction surface DS that is formed on the cemented surface of the cemented lens provided within the first lens group (G1, G1′ and G1″) (the incident angle at the diffraction surface DS at the maximum image height), i.e., the diffraction surface incident angle (°). If the diffraction surface incident angle θ becomes large, flare easily occurs at the diffraction surface DS, and hence, it is desirable for the diffraction surface incident angle θ to be as small as possible. In case of the optical system of the illustrated embodiments, it is desirable for the diffraction surface incident angle θ to be 13° or less. FIG. 50 shows the diffraction efficiency of the diffraction surface DS in the case where the diffraction surface incident angle θ is 0°, and FIG. 51 shows the diffraction efficiency of the diffraction surface DS in the case where the diffraction surface incident angle θ is 13°. FIGS. 50 and 51 show the case where the grating pitch P of the diffraction surface DS is 200 μm, the grating thickness d of the diffraction surface DS is 22.4 μm, the 1^{st} order diffraction light is the design order, and the 0^{th} order diffraction light and the 2^{nd} order diffraction light as unwanted light (flare component). Upon comparing FIG. 50 with FIG. 51, even if the diffraction surface incident angle θ changes from 0° to 13°, practically almost no change occurs in the diffraction efficiency therebetween.

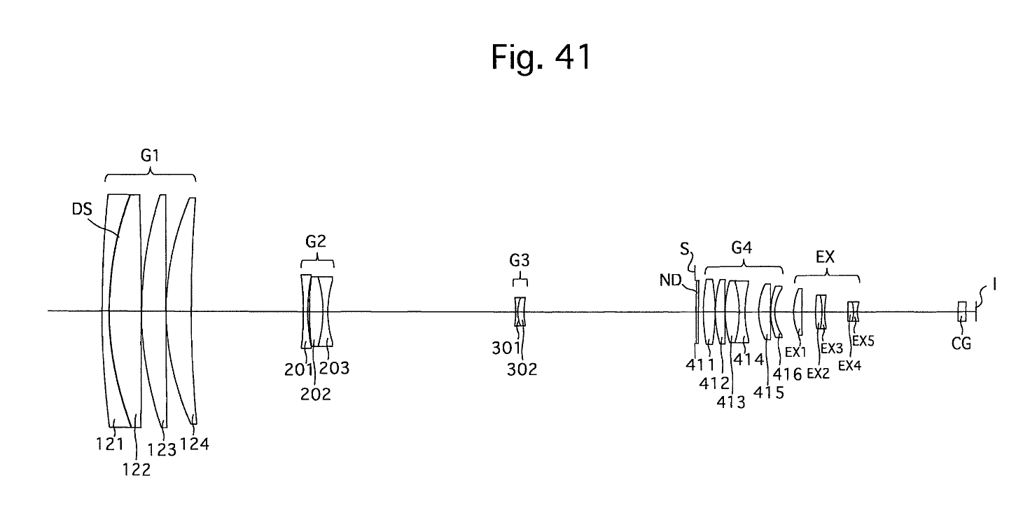

Furthermore, the zoom lens system of the illustrated embodiments can be provided with an insertable/removable extender (rear converter) in order to change the focal length of the entire lens system at the long focal length side to any position on the optical path (e.g., to double the focal length), as shown, e.g., in the Reference Example (FIG. 41) which will be discussed later.

Conditions (1) and (1′) specify the power of the diffraction surface DS that is provided within the first lens group (G1, G1′ and G1″). By satisfying condition (1), chromatic aberration can be favorably corrected from the visible region to the near infra-red region over the entire zooming range, and spherical aberration at mainly the long focal length extremity and coma, etc., can be favorably corrected, thereby achieving a superior optical quality. This effect is more noticeable if condition (1′) is satisfied.

If the upper limit of condition (1) or (1′) is exceeded, the power of the diffraction surface DS becomes too weak, so that the chromatic aberration correction via the diffraction surface becomes insufficient. Furthermore, due to the radius of curvature of the substrate surface having the diffraction surface DS becoming small, it becomes difficult to correct spherical aberration, coma and chromatic aberration that occur mainly at the long focal length extremity.

If the lower limit of condition (1) is exceeded, the power of the diffraction surface DS becomes too strong, so that the chromatic aberrations becomes over corrected.

Condition (2) specifies the ratio of the focal length of the first lens group (G1, G1′ or G1″) to the focal length of the entire focal length at the long focal length extremity. By satisfying condition (2), the lens system can be miniaturized, lateral chromatic aberration, spherical aberration and coma, etc., can be favorably corrected, and a superior optical quality can be achieved. This effect is more prominent if condition (2′) is satisfied.

If the upper limit of condition (2) is exceeded, the power of the first lens group becomes too weak, the overall length of the lens system increases, and the diameter of the frontmost lens element also becomes large. Accordingly, the paraxial light rays that pass through the first lens group increase in height, thereby worsening the lateral chromatic aberration at the short focal length extremity and the long focal length extremity.

If the lower limit of condition (2′) is exceeded, the power of the first lens group becomes too strong, so that spherical aberration and coma, etc., worsen, mainly at the long focal length extremity.

Condition (3) specifies the Abbe number at the d-line of the negative lens element provided within the first lens group (G1, G1′ or G1″). By providing a negative lens element having an Abbe number that satisfies condition (3) within the first lens group, lateral chromatic aberration at the short focal length extremity and axial chromatic aberration at the long focal length extremity can be favorably corrected, so that a superior optical quality can be achieved.

If the lower limit of condition (3) is exceeded, lateral chromatic aberration at the short focal length extremity and axial chromatic aberration at the long focal length extremity become over corrected.

Condition (4) specifies the partial dispersion ratio of the negative lens element provided in the first lens group (G1, G1′ and G1″). By providing a negative lens element having a partial dispersion ratio that satisfies condition (4) within the first lens group, axial chromatic aberration can be favorably corrected from the visible region to the near infra-red region at the long focal length extremity, so that a superior optical quality can be achieved.

If the upper limit of condition (4) is exceeded, a secondary spectrum remains mainly at the long focal length side, so that correction of axial chromatic aberration from the visible region to the near infra-red region at the long focal length extremity becomes difficult.

Furthermore, examples of glass materials that satisfy conditions (3) and (4) are, e.g., HOYA NBFD15 (νd=33.3, θgF=0.5883) produced by HOYA Corporation, and OHARA S-LAH60 (νd=37.2, θgF=0.5776) produced by OHARA Inc.

Condition (5) specifies the Abbe number at the d-line of a positive lens element(s) provided within the first lens group (G1, G1′ and G1″). By providing a positive lens element(s) having an Abbe number that satisfies condition (5) within the first lens group, lateral chromatic aberration at the short focal length extremity and axial chromatic aberration at the long focal length extremity can be favorably corrected, so that a superior optical quality can be achieved.

If the lower limit of condition (5) is exceeded, it becomes difficult to correct lateral chromatic aberration at the short focal length extremity and axial chromatic aberration at the long focal length extremity.

Furthermore, examples of glass materials that satisfy condition (5) are, e.g., SUMITAK-GFK70 (νd=71.3, θgF=0.5450) produced by Sumita Optical Glass, Inc., and OHARA S-FPL51 (νd=81.6, θgF=0.5375) produced by OHARA Inc.

Condition (6) specifies the ratio of the focal length of the first lens group (G1, G1′ and G1″) to the thickness of the first lens group (G1, G1′ and G1″). By satisfying condition (6), the lens system can be miniaturized, lateral chromatic aberration, spherical aberration and coma, etc., can be favorably corrected, and a superior optical quality can be achieved.

If the upper limit of condition (6) is exceeded, the power of the first lens group becomes too weak, the entire length of the lens system becomes long, and the frontmost lens diameter becomes large. Accordingly, paraxial light rays passing through the first lens group increase in height, so that lateral chromatic aberration at the short focal length extremity and at the long focal length extremity worsen.

If the lower limit of condition (6) is exceeded, the power of the first lens group becomes too strong, so that spherical aberration and coma, etc., worsen, mainly at the long focal length extremity.

Condition (7) specifies the Abbe number at the d-line of the positive lens element provided within the second lens group (G2, G2′ and G2″). By providing a positive lens element that satisfies condition (7) within the second lens group, lateral chromatic aberration at the short focal length extremity can be favorably corrected and a superior optical quality can be achieved.

If the upper limit of condition (7) is exceeded, it becomes difficult to correct lateral chromatic aberration mainly at the short focal length extremity.

Furthermore, examples of glass materials that satisfy condition (7) are, e.g., OHARA S-NPH1 (νd=22.8, θgF=0.6307) produced by OHARA, Inc., and OHARA S-NPH2 (νd=18.9, θgF=0.6495).

Condition (8) specifies the power of the second lens group (G2, G2′ and G2″). By satisfying condition (8), a high zoom ratio can be maintained while shortening the overall length of the lens system, and lateral chromatic aberration, field curvature and coma, etc., can be favorably corrected, so that a superior optical quality can be achieved.

If the upper limit of condition (8) is exceeded, the power of the second lens group becomes too weak, so that if attempts are mode to maintain a high zoom ratio, the overall length of the lens system becomes long. Accordingly, the paraxial light rays that pass through the first lens group and the second lens group increase in height mainly at the short focal length extremity, and lateral chromatic aberration worsens.

If the lower limit of condition (8) is exceeded, the power of the second lens group becomes too strong, so that positive field curvature occurs over the entire zooming range, and coma also worsens.

Condition (9) specifies the lateral magnification of the stationary lens groups (the fourth lens group G4, the fourth lens group G4′ and the fifth lens group G5″) which remain stationary when zooming at a position closest to the image side. By satisfying condition (9), spherical aberration and coma at the short focal length extremity can be favorably corrected, and a superior optical quality can be achieved.

If the upper limit of condition (9) is exceeded, the lateral magnification of the stationary lens group becomes too large, and spherical aberration and coma worsen mainly at the short focal length extremity.

Condition (10) specifies the Abbe number at the d-line of the positive lens elements provided within the stationary lens groups (the fourth lens group G4, the fourth lens group G4′ and the fifth lens group G5″) which remain stationary when zooming at a position closest to the image side. By providing a positive lens element that satisfies condition (10) within the stationary lens group, axial chromatic aberration mainly at the short focal length extremity can be favorably corrected, thereby achieving a superior optical quality.

If the lower limit of condition (10) is exceeded, axial chromatic aberration mainly at the short focal length extremity becomes difficult to correct.

Furthermore, examples of glass materials that satisfy condition (10) are, e.g., SUMITA K-GFK70 (νd=71.3) produced by Sumita Optical Glass, Inc., and OHARA S-FPL51 (νd=81.6).

As described above, in the first through fifth numerical embodiments, the third lens group G3 has a negative refractive power. With this configuration, condition (11) specifies the ratio of the power of the negative second lens group to the power of the negative third lens group. By satisfying condition (11), a high zoom ratio is ensured while field curvature, coma and lateral chromatic aberration are favorably corrected, thereby achieving superior optical quality.

If the upper limit of condition (11) is exceeded, the negative power of the third lens group G3 becomes too strong, so that fluctuation in field curvature during zooming becomes large.

If the lower limit of condition (11) is exceeded, the negative power of the third lens group G3 becomes too weak, so that it becomes necessary to strengthen the negative power of the second lens group G2 in order to attain a high zoom ratio, and correction of coma and lateral chromatic aberration over the entire zooming range becomes difficult.

Conditions (12), (12′) and (12″) normalize the power of the diffraction surface DS using the power of the first lens group (G1, G1′ and G1″). By satisfying condition (12), various aberrations mainly at the long focal length extremity such as spherical aberration and coma, etc., can be favorably corrected, and a superior optical quality can be achieved. Furthermore, by satisfying conditions (12′) and (12″), axial chromatic aberration mainly at the long focal length extremity can be favorably corrected, thereby achieving a superior optical quality.

If the lower limit of conditions (12) and (12′) are exceeded, the power of the diffraction DS becomes too strong, so that axial chromatic aberration mainly at the long focal length extremity becomes over corrected.

If the upper limit of conditions (12′) and (12″) are exceeded, the power of the diffraction surface DS becomes too weak, so that correction of axial chromatic aberration mainly at the long focal length extremity becomes insufficient.

Condition (13) specifies the partial dispersion ratio and the Abbe number at the d-line of the positive lens elements provided within the first lens group (G1, G1′ and G1″). By satisfying condition (13), mainly at the long focal length extremity, a secondary spectrum can be prevented from remaining while favorably correcting axial chromatic aberration at the g-line and chromatic aberration in the visible region, so that a superior optical quality can be achieved.

If the lower limit of condition (13) is exceeded, mainly at the long focal length extremity, a secondary spectrum remains, axial chromatic aberration at the g-line becomes over corrected, and chromatic aberration in the visible region worsens.

Condition (14) specifies the partial dispersion ratio and the Abbe number at the d-line of the positive lens elements provided within the second lens group (G2, G2′ and G2″). By satisfying condition (14), with respect to mainly at the long focal length extremity, a secondary spectrum can be prevented from remaining while favorably correcting axial chromatic aberration at the g-line and chromatic aberration in the visible region, so that a superior optical quality can be achieved.

If the lower limit of condition (14) is exceeded, with respect to mainly at the long focal length extremity, a secondary spectrum remains, axial chromatic aberration at the g-line becomes over corrected and chromatic aberration in the visible region worsens.

Conditions (15) and (15′) normalize the power of the diffraction surface DS provided within the first lens group (G1, G1′ and G1″) using the focal length of the entire lens system at the long focal length extremity. By satisfying condition (15), axial chromatic aberration mainly at the long focal length extremity can be favorably corrected, so that a superior optical quality can be achieved.

If the lower limits of conditions (15) and (15′) are exceeded, the power of the diffraction surface DS becomes too strong, so that axial chromatic aberration mainly at the long focal length extremity becomes over corrected.

If the upper limit of condition (15′) is exceeded, the power of the diffraction surface DS becomes too weak, so that correction of axial chromatic aberration mainly at the long focal length extremity becomes insufficient.

As described above, in the first through fifth, ninth and tenth numerical embodiments, the second lens group G2 is configured of a negative lens element 201, and a cemented lens having a positive lens element 202 and a negative lens element 203, in that order from the object side.

With this configuration, condition (16) specifies the profile (shape factor) of the negative lens element 201 which is provided closest to the object side within the second lens group G2. By satisfying condition (16), spherical aberration mainly at the long focal length extremity can be favorably corrected, so that a superior optical quality can be achieved.

If the upper limit of condition (16) is exceeded, the radius of curvature of the concave surface on the object side of the negative lens element 201 becomes too large, and spherical aberration remaining in the first lens group G1 becomes difficult to correct, so that correction of spherical aberration mainly at the long focal length extremity becomes insufficient.

If the lower limit of condition (16) is exceeded, the radius of curvature of the concave surface on the object side of the negative lens element 201 becomes too small, so that spherical aberration mainly at the long focal length extremity becomes over corrected.

### EMBODIMENTS

Specific first through tenth numerical embodiments will be herein discussed. In the various aberration diagrams and the tables, S designates the sagittal image, M designates the meridional image, FNO. designates the f-number, f designates the focal length of the entire optical system, W designates the half angle of view (°), Y designates the image height, fB designates the backfocus, L designates the overall length of the lens system, R designates the radius of curvature, d designates the lens thickness or distance between lenses, N(d) designates the refractive index at the d-line, ν(d) designates the Abbe number with respect to the d-line, and θgF indicates a partial dispersion ratio. Furthermore, the diffraction surface incidence angle (°) refers to the angle between each principal ray, which is incident on the diffraction surface DS formed on the cemented surface of the cemented lens provided within the first lens group (G1, G1′ and G1″), and the optical axis (the incident angle at the diffraction surface at a maximum image height). The values for the f-number, the focal length, the half angle-of-view, the image height, the backfocus, the overall length of the lens system, the distance d between lenses (which changes during zooming), and the diffraction surface incident angle (°) are shown in the following order: short focal length extremity, intermediate focal length, and long focal length extremity. The unit used for lengths is defined in millimeters (mm).

### Numerical Embodiment 1

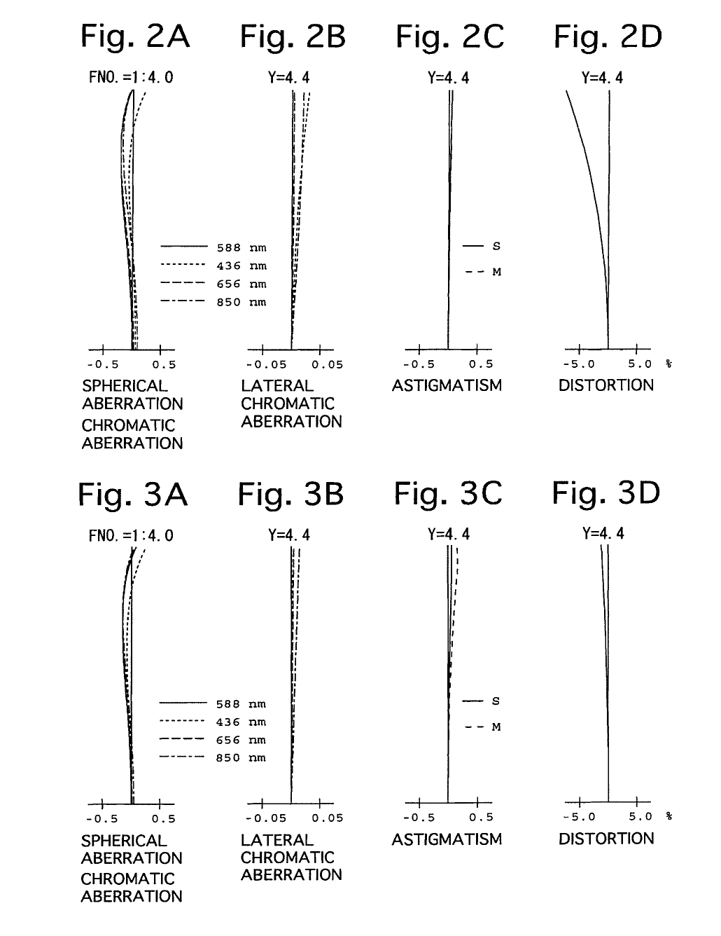

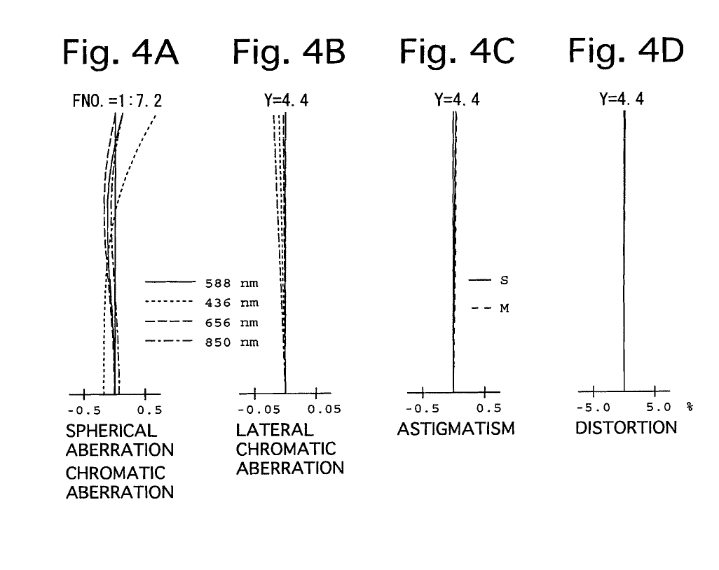

FIGS. 1 through 4 and Tables 1 through 3 show a first numerical embodiment of the zoom lens system according to the present invention. FIG. 1 shows the lens arrangement at the short focal length extremity when focused on an object at infinity. FIGS. 2, 3 and 4 show various aberration diagrams at the short focal length extremity, at an intermediate focal length and at the long focal length extremity, respectively, when focused on an object at infinity. Table 1 shows the lens surface data, Table 2 shows various lens-system data, and Table 3 shows the lens group data.

The zoom lens system of the first numerical embodiment is configured of a positive first lens group G1, a negative second lens group G2, a negative third lens group G3 and a positive fourth lens group G4, in that order from the object side (four lens groups constituting a positive-negative-negative-positive lens group configuration of a zoom lens system). An ND filter ND for light-quantity adjustment and an aperture diaphragm S are provided, in that order from the object side, between the third lens group G3 and the fourth lens group G4 (immediately in front of the fourth lens group G4). A protective glass (cover glass) CG for protecting the imaging surface I is provided between the fourth lens group G4 and the imaging surface I.

The first lens group G1 is configured of a negative meniscus lens element 101 having a convex surface on the object side, a biconvex positive lens element 102 and a biconvex positive lens element 103, in that order from the object side. The surface on the image side of the negative meniscus lens element 101 and the surface on the object side of the biconvex positive lens element 102 are cemented to each other, and the diffraction surface DS, which has a rotationally symmetric shape with respect to the optical axis, is formed on the cemented surface thereof.

The second lens group G2 is configured of a biconcave negative lens element 201, a biconvex positive lens element 202 and a biconcave negative lens element 203, in that order from the object side. The surface on the image side of the biconvex positive lens element 202 and the surface on the object side of the biconcave negative lens element 203 are cemented to each other.

The third lens group G3 is configured of a biconcave negative lens element 301 and a positive meniscus lens element 302 having a convex surface on the object side, in that order from the object side. The surface on the image side of the biconcave negative lens element 301 and the surface on the object side of the positive meniscus lens element 302 are cemented to each other.

The fourth lens group G4 is configured of a biconvex positive lens element 401, a biconvex positive lens element 402, a negative meniscus lens element 403 having a convex surface on the image side, a biconvex positive lens element 404 and a negative meniscus lens element 405 having a convex surface on the object side, in that order from the object side. The surface on the image side of the biconvex positive lens element 402 and the surface on the object side of the negative meniscus lens element 403 are cemented to each other.

TABLE 1
SURFACE DATA

| Surf. No. | R | d | N(d) | ν(d) | θgF |
|---|---|---|---|---|---|
| 1 | 216.879 | 2.650 | 1.78590 | 44.2 | 0.5631 |
| 2 | 100.172 | 0.100 | 1.61505 | 26.5 | 0.6153 |
| 3* | 100.172 | 0.100 | 1.64310 | 38.8 | 0.5799 |
| 4 | 100.172 | 14.582 | 1.43875 | 95.0 | 0.5340 |
| 5 | −997.512 | 0.200 | | | |
| 6 | 98.849 | 13.037 | 1.43875 | 95.0 | 0.5340 |
| 7 | −11842.277 | d7 | | | |
| 8 | −200.974 | 2.000 | 1.83400 | 37.2 | 0.5776 |
| 9 | 1582.645 | 0.720 | | | |
| 10 | 155.877 | 8.170 | 1.80810 | 22.8 | 0.6307 |
| 11 | −102.601 | 2.000 | 1.77250 | 49.6 | 0.5503 |
| 12 | 51.953 | d12 | | | |
| 13 | −68.946 | 1.200 | 1.69680 | 55.5 | 0.5425 |
| 14 | 15.570 | 3.290 | 1.80610 | 33.3 | 0.5883 |
| 15 | 38.015 | d15 | | | |
| 16 | ∞ | 1.000 | 1.51680 | 64.2 | 0.5343 |
| 17 | ∞ | 0.900 | | | |
| 18(Diaphragm) | ∞ | 2.500 | | | |
| 19 | 87.428 | 3.260 | 1.49700 | 81.6 | 0.5375 |
| 20 | −91.053 | 0.100 | | | |
| 21 | 176.868 | 5.810 | 1.59522 | 67.7 | 0.5442 |
| 22 | −23.802 | 1.800 | 1.79952 | 42.2 | 0.5672 |
| 23 | −270.286 | 4.940 | | | |
| 24 | 56.038 | 5.520 | 1.59522 | 67.7 | 0.5442 |
| 25 | −71.458 | 0.200 | | | |
| 26 | 31.951 | 3.000 | 1.69680 | 55.5 | 0.5425 |
| 27 | 23.069 | 78.760 | | | |
| 28 | ∞ | 3.500 | 1.51680 | 64.2 | 0.5343 |
| 29 | ∞ | — | | | |

Optical Path Difference Function Coefficients for Diffraction
Surface DS

| | | |
|---|---|---|
| NO. 3 | P2 = −8.69915E−04 | P4 = 8.18449E−07 |

Partial Dispersion Ratio for Negative lens element 101
θgF = 0.5631

TABLE 2
VARIOUS LENS SYSTEM DATA
Zoom Ratio: 38.82

| | | | Long |
|---|---|---|---|
| | Short Focal Length | Intermediate | Focal Length |
| | Extremity | Focal Length | Extremity |
| FNO. | 4.0 | 4.0 | 7.2 |
| f | 17.00 | 105.90 | 660.00 |
| W | 15.6 | 2.4 | 0.4 |
| Y | 4.40 | 4.40 | 4.40 |
| fB | 1.00 | 1.00 | 1.00 |
| L | 368.47 | 368.47 | 368.47 |
| d7 | 4.471 | 107.944 | 131.626 |
| d12 | 150.272 | 51.766 | 73.000 |
| d15 | 53.391 | 48.424 | 3.507 |
| Diffraction Surface | 11.98 | 3.90 | 0.78 |
| Incidence Angle (°) | | | |

TABLE 3
LENS GROUP DATA

| Lens Group | 1^{st} Surf. | Focal Length |
|---|---|---|
| 1 | 1 | 197.83 |
| 2 | 8 | −71.22 |
| 3 | 13 | −40.80 |
| 4 | 16 | 48.11 |

### Numerical Embodiment 2

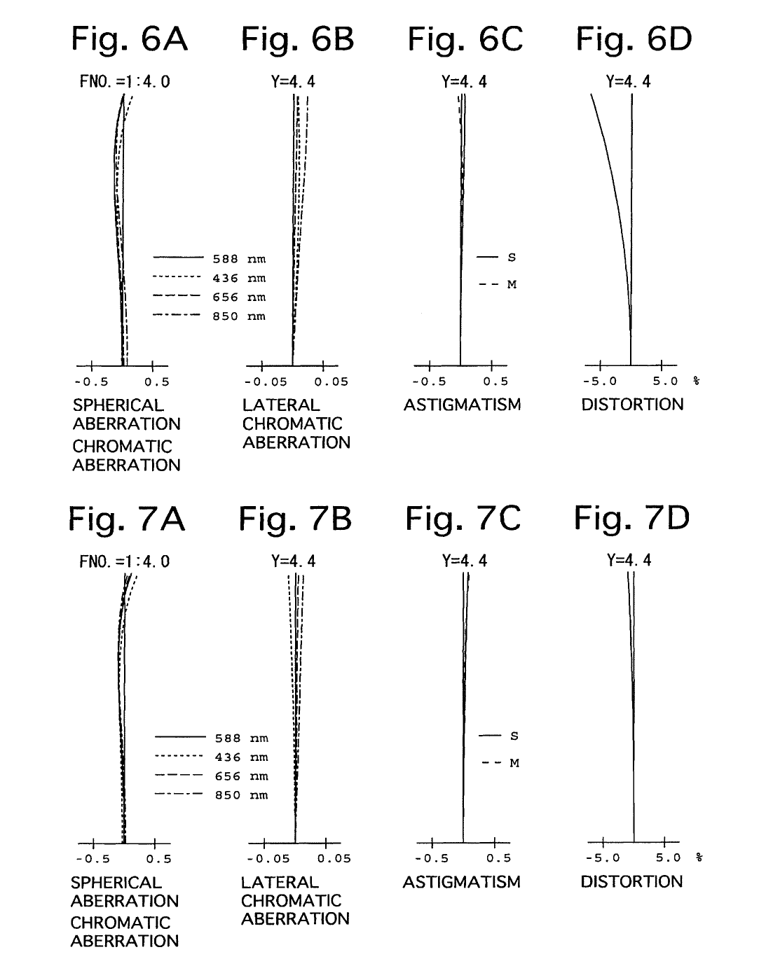

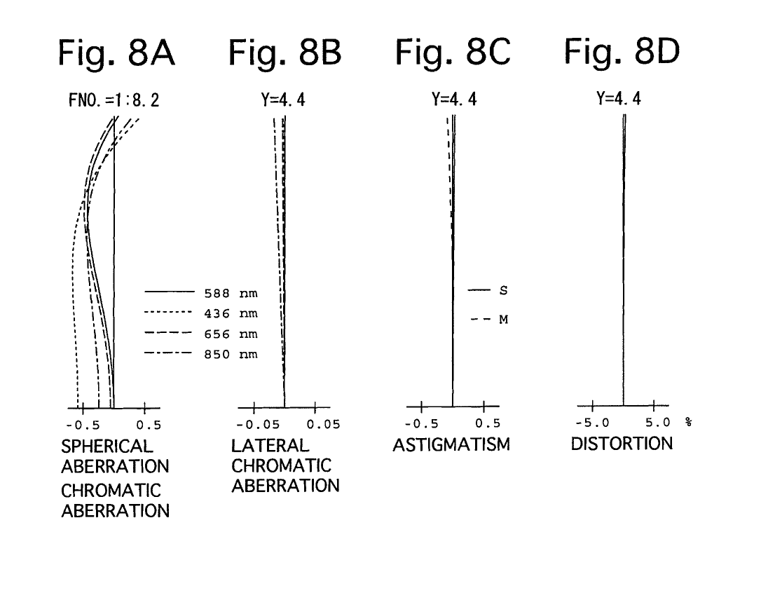

FIGS. 5 through 8 and Tables 4 through 6 show a second numerical embodiment of the zoom lens system according to the present invention. FIG. 5 shows the lens arrangement at the short focal length extremity when focused on an object at infinity. FIGS. 6, 7 and 8 show various aberration diagrams at the short focal length extremity, at an intermediate focal length and at the long focal length extremity, respectively, when focused on an object at infinity. Table 4 shows the lens surface data, Table 5 shows various lens-system data, and Table 6 shows the lens group data.

The lens arrangement of the second numerical embodiment is the same as that of the first numerical embodiment except for the following:

(1) The first lens group G1 is configured of a negative meniscus lens element 111 having a convex surface on the object side, a biconvex positive lens element 112, a negative meniscus lens element 113 having a convex surface on the object side, a positive meniscus lens element 114 having a convex surface on the object side, and a biconvex positive lens element 115, in that order from the object side. The surface on the image side of the negative meniscus lens element 111 and the surface on the object side of the biconvex positive lens element 112 are cemented to each other. The surface on the image side of the negative meniscus lens element 113 and the surface on the object side of the positive meniscus lens element 114 are cemented to each other, and the diffraction surface DS, which has a rotationally symmetric shape with respect to the optical axis, is formed on the cemented surface thereof.

(2) The fourth lens group G4 is configured of a biconvex positive lens element 411, a biconvex positive lens element 412, a biconvex positive lens element 413, a biconcave negative lens element 414, a positive meniscus lens element 415 having a convex surface on the object side, and a negative meniscus lens element 416 having a convex surface on the object side, in that order from the object side. The surface on the image side of the biconvex positive lens element 413 and the surface on the object side of the biconcave negative lens element 414 are cemented to each other.

(3) An aperture diaphragm S and an ND filter ND for light-quantity adjustment are provided, in that order from the object side, between the third lens group G3 and the fourth lens group G4 (immediately in front of the fourth lens group G4).

TABLE 4
SURFACE DATA

| Surf. No. | R | d | N(d) | ν(d) | θgF |
|---|---|---|---|---|---|
| 1 | 1170.022 | 3.000 | 1.73400 | 51.5 | 0.5486 |
| 2 | 115.198 | 22.417 | 1.49700 | 81.6 | 0.5375 |
| 3 | −567.926 | 2.871 | | | |
| 4 | 211.429 | 2.000 | 1.45600 | 91.4 | 0.5342 |
| 5 | 95.104 | 0.100 | 1.61505 | 26.5 | 0.6153 |
| 6* | 95.104 | 0.100 | 1.64310 | 38.8 | 0.5799 |
| 7 | 95.104 | 19.649 | 1.43875 | 95.0 | 0.5340 |
| 8 | 683.806 | 0.328 | | | |
| 9 | 111.223 | 16.499 | 1.43875 | 95.0 | 0.5340 |
| 10 | −1357.053 | d10 | | | |
| 11 | −777.257 | 2.583 | 1.80100 | 35.0 | 0.5864 |
| 12 | 57.023 | 16.039 | | | |
| 13 | 251.491 | 8.123 | 1.92286 | 18.9 | 0.6495 |
| 14 | −115.994 | 4.522 | 1.83400 | 37.2 | 0.5776 |
| 15 | 444.629 | d15 | | | |
| 16 | −44.341 | 2.151 | 1.61800 | 63.4 | 0.5441 |
| 17 | 15.146 | 2.821 | 1.80610 | 33.3 | 0.5883 |
| 18 | 29.354 | d18 | | | |
| 19(Diaphragm) | ∞ | 0.600 | | | |
| 20 | ∞ | 1.000 | 1.51633 | 64.1 | 0.5353 |
| 21 | ∞ | 2.200 | | | |
| 22 | 59.748 | 5.514 | 1.43875 | 95.0 | 0.5340 |
| 23 | −61.522 | 0.100 | | | |
| 24 | 48.537 | 4.434 | 1.43875 | 95.0 | 0.5340 |
| 25 | −482.217 | 0.100 | | | |
| 26 | 40.828 | 6.240 | 1.49700 | 81.6 | 0.5375 |
| 27 | −40.978 | 2.200 | 1.77250 | 49.6 | 0.5520 |
| 28 | 41.023 | 4.853 | | | |
| 29 | 26.546 | 8.355 | 1.61800 | 63.4 | 0.5441 |
| 30 | 519.733 | 0.100 | | | |
| 31 | 38.524 | 2.770 | 1.69350 | 53.2 | 0.5473 |
| 32 | 17.200 | 53.146 | | | |
| 33 | ∞ | 3.500 | 1.51633 | 64.1 | 0.5353 |
| 34 | ∞ | — | | | |

Optical Path Difference Function Coefficients for Diffraction
Surface DS

| | | |
|---|---|---|
| NO. 6 | P2 = −9.55455E−04 | P4 = 9.22081E−07 |

Partial Dispersion Ratio for Negative lens element 111
θgF = 0.5486
Partial Dispersion Ratio for Negative lens element 113
θgF = 0.5342

TABLE 5
VARIOUS LENS SYSTEM DATA
Zoom Ratio: 58.22

| | Short Focal Length | Intermediate | Long Focal Length |
|---|---|---|---|
| | Extremity | Focal Length | Extremity |
| FNO. | 4.0 | 4.0 | 8.2 |
| f | 14.60 | 111.40 | 850.00 |
| W | 17.9 | 2.3 | 0.3 |
| Y | 4.40 | 4.40 | 4.40 |
| fB | 1.00 | 1.00 | 1.00 |
| L | 394.41 | 394.41 | 394.41 |
| d10 | 4.640 | 120.268 | 135.139 |
| d15 | 118.095 | 10.459 | 55.986 |
| d18 | 72.358 | 64.366 | 3.969 |

Diffraction Surface Incidence Angle (°)

| | | |
|---|---|---|
| 15.51 | 6.04 | 1.12 |

TABLE 6
LENS GROUP DATA

| Lens Group | 1^{st} Surf. | Focal Length |
|---|---|---|
| 1 | 1 | 196.49 |
| 2 | 11 | −83.28 |
| 3 | 16 | −34.11 |
| 4 | 19 | 44.38 |

### Numerical Embodiment 3

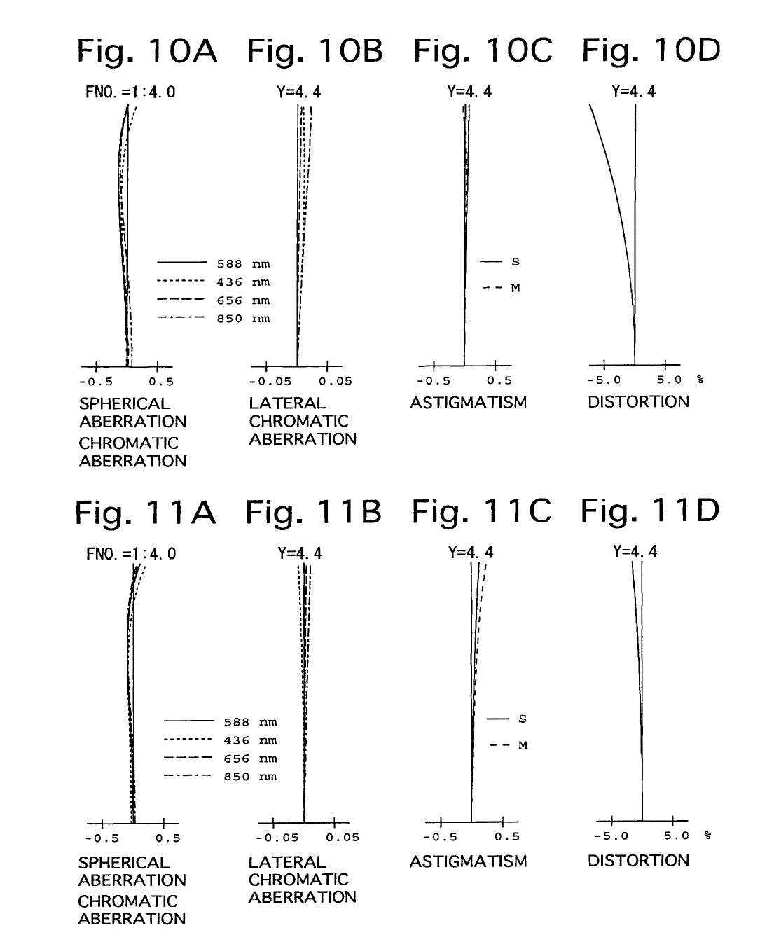

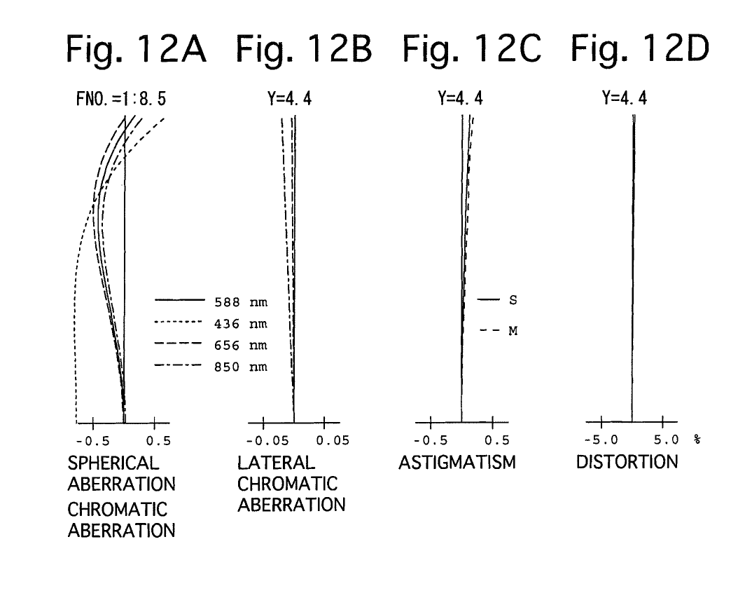

FIGS. 9 through 12 and Tables 7 through 9 show a third numerical embodiment of the zoom lens system according to the present invention. FIG. 9 shows the lens arrangement at the short focal length extremity when focused on an object at infinity. FIGS. 10, 11 and 12 show various aberration diagrams at the short focal length extremity, at an intermediate focal length and at the long focal length extremity, respectively, when focused on an object at infinity. Table 7 shows the lens surface data, Table 8 shows various lens-system data, and Table 9 shows the lens group data.

The lens arrangement of the third numerical embodiment is the same as that of the second numerical embodiment except for the following:

(1) The first lens group G1 is configured of a biconcave negative lens element 121, a biconvex positive lens element 122, a positive meniscus lens element 123 having a convex surface on the object side, and a positive meniscus lens element 124 having a convex surface on the object side, in that order from the object side. The surface on the image side of the biconcave negative lens element 121 and the surface on the object side of the biconvex positive lens element 122 are cemented to each other, and the diffraction surface DS, which has a rotationally symmetric shape with respect to the optical axis, is formed on the cemented surface thereof.

TABLE 7
SURFACE DATA

| Surf. No. | R | d | N(d) | ν (d) | θ g F |
|---|---|---|---|---|---|
| 1 | −1428.542 | 3.000 | 1.63854 | 55.4 | 0.5484 |
| 2 | 120.918 | 0.100 | 1.61505 | 26.5 | 0.6153 |
| 3* | 120.918 | 0.100 | 1.64310 | 38.8 | 0.5799 |
| 4 | 120.918 | 19.289 | 1.43875 | 95.0 | 0.5340 |
| 5 | −306.976 | 0.200 | | | |
| 6 | 123.470 | 16.296 | 1.43875 | 95.0 | 0.5340 |
| 7 | 11138.787 | 0.200 | | | |
| 8 | 133.828 | 10.261 | 1.43875 | 95.0 | 0.5340 |
| 9 | 358.432 | d9 | | | |
| 10 | −777.257 | 2.583 | 1.80100 | 35.0 | 0.5864 |
| 11 | 57.023 | 16.039 | | | |
| 12 | 251.491 | 8.123 | 1.92286 | 18.9 | 0.6495 |
| 13 | −115.994 | 4.522 | 1.83400 | 37.2 | 0.5776 |
| 14 | 444.629 | d14 | | | |
| 15 | −44.341 | 2.151 | 1.61800 | 63.4 | 0.5441 |
| 16 | 15.146 | 2.821 | 1.80610 | 33.3 | 0.5883 |
| 17 | 29.354 | d17 | | | |
| 18(Diaphragm) | ∞ | 0.600 | | | |
| 19 | ∞ | 1.000 | 1.51633 | 64.1 | 0.5353 |
| 20 | ∞ | 2.200 | | | |
| 21 | 59.748 | 5.514 | 1.43875 | 95.0 | 0.5340 |
| 22 | −61.522 | 0.100 | | | |
| 23 | 48.537 | 4.434 | 1.43875 | 95.0 | 0.5340 |
| 24 | −482.217 | 0.100 | | | |
| 25 | 40.828 | 6.240 | 1.49700 | 81.6 | 0.5375 |
| 26 | −40.978 | 2.200 | 1.77250 | 49.6 | 0.5520 |
| 27 | 41.023 | 4.853 | | | |
| 28 | 26.546 | 8.355 | 1.61800 | 63.4 | 0.5441 |
| 29 | 519.733 | 0.100 | | | |
| 30 | 38.524 | 2.770 | 1.69350 | 53.2 | 0.5473 |
| 31 | 17.200 | 53.151 | | | |
| 32 | ∞ | 3.500 | 1.51633 | 64.1 | 0.5353 |
| 33 | ∞ | — | | | |

Optical Path Difference Function Coefficients for Diffraction
Surface DS

| | | |
|---|---|---|
| NO. 3 | P2 = −3.21564E−03 | P4 = 8.26001E−07 |

Partial Dispersion Ratio for Negative Lens Element 121

θ gF = 0.5484

TABLE 8
VARIOUS LENS SYSTEM DATA
Zoom Ratio: 58.62

| | Short Focal Length | Intermediate | Long Focal Length |
|---|---|---|---|
| | Extremity | Focal Length | Extremity |
| FNO. | 4.0 | 4.0 | 8.5 |
| f | 14.50 | 111.00 | 850.00 |
| W | 18.2 | 2.3 | 0.3 |
| Y | 4.40 | 4.40 | 4.40 |
| fB | 1.00 | 1.00 | 1.00 |
| L | 377.10 | 377.10 | 377.10 |
| d9 | 4.909 | 121.462 | 136.468 |
| d14 | 118.025 | 9.453 | 55.122 |
| d17 | 72.359 | 64.377 | 3.702 |

Diffraction Surface Incidence Angle (°)

| | | |
|---|---|---|
| 10.14 | 0.52 | 0.03 |

TABLE 9
LENS GROUP DATA

| Lens Group | 1^{st} Surf. | Focal Length |
|---|---|---|
| 1 | 1 | 196.52 |
| 2 | 10 | −83.28 |
| 3 | 15 | −34.11 |
| 4 | 18 | 44.38 |

### Numerical Embodiment 4

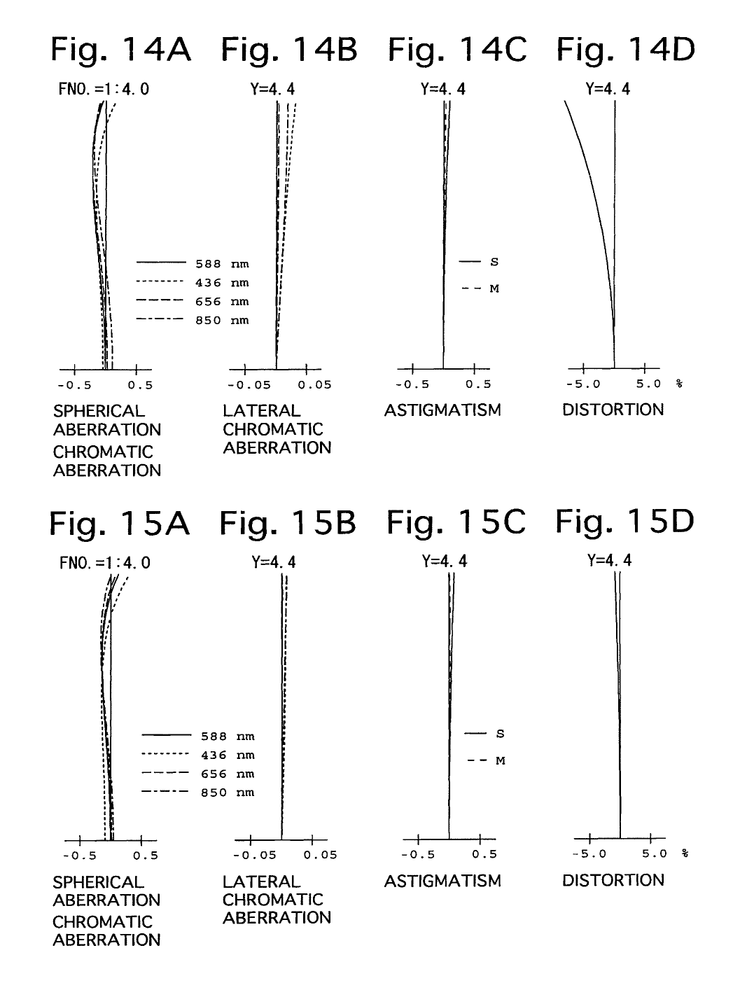

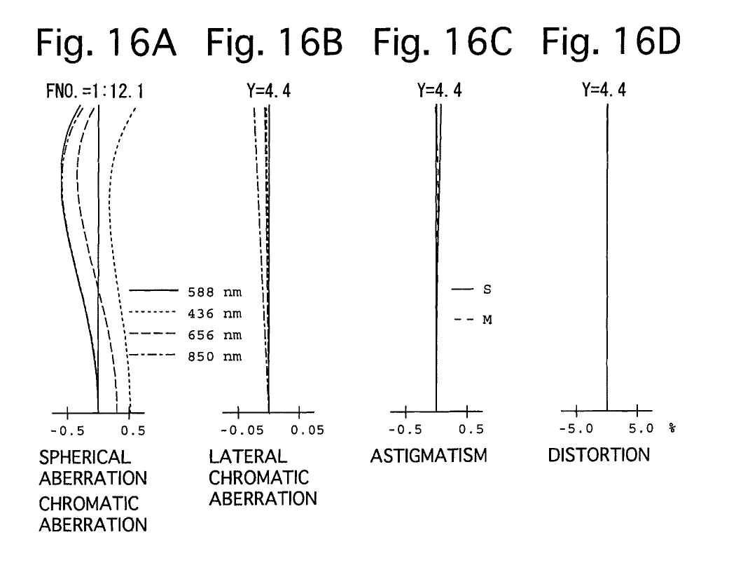

FIGS. 13 through 16 and Tables 10 through 12 show a fourth numerical embodiment of the zoom lens system according to the present invention. FIG. 13 shows the lens arrangement at the short focal length extremity when focused on an object at infinity. FIGS. 14, 15 and 16 show various aberration diagrams at the short focal length extremity, at an intermediate focal length and at the long focal length extremity, respectively, when focused on an object at infinity. Table 10 shows the lens surface data, Table 11 shows various lens-system data, and Table 12 shows the lens group data.

The lens arrangement of the fourth numerical embodiment is the same as that of the first numerical embodiment except for the following:

(1) The first lens group G1 is configured of a negative meniscus lens element 121 having a convex surface on the object side, a biconvex positive lens element 122, a positive meniscus lens element 123 having a convex surface on the object side, and a positive meniscus lens element 114 having a convex surface on the object side, in that order from the object side. The surface on the image side of the negative meniscus lens element 121 and the surface on the object side of the biconvex positive lens element 122 are cemented to each other, and the diffraction surface DS, which has a rotationally symmetric shape with respect to the optical axis, is formed on the cemented surface thereof.

(2) The fourth lens group G4 is configured of a biconvex positive lens element 421, a biconvex positive lens element 422, a negative meniscus lens element 423 having a convex surface on the image side, a positive meniscus lens element 424 having a convex surface on the object side, a negative meniscus lens element 425 having a convex surface on the object side, a negative meniscus lens element 426 having a convex surface on the object side, and a biconvex positive lens element 427, in that order from the object side. The surface on the image side of the biconvex positive lens element 422 and the surface on the object side of the negative meniscus lens element 423 are cemented to each other. The surface on the image side of the negative meniscus lens element 426 and the surface on the object side of the biconvex positive lens element 427 are cemented to each other.

TABLE 10
SURFACE DATA

| Surf. No. | R | d | N(d) | ν (d) | θ g F |
|---|---|---|---|---|---|
| 1 | 12507.133 | 3.500 | 1.80610 | 33.3 | 0.5883 |
| 2 | 209.485 | 0.100 | 1.61505 | 26.5 | 0.6153 |
| 3* | 209.485 | 0.100 | 1.64310 | 38.8 | 0.5799 |
| 4 | 209.485 | 16.401 | 1.56908 | 71.3 | 0.5450 |
| 5 | −425.363 | 0.200 | | | |
| 6 | 175.768 | 13.241 | 1.48749 | 70.2 | 0.5300 |
| 7 | 863.889 | 0.200 | | | |
| 8 | 121.699 | 10.144 | 1.51633 | 64.1 | 0.5353 |
| 9 | 290.106 | d9 | | | |
| 10 | −185.266 | 2.406 | 1.83400 | 37.2 | 0.5776 |
| 11 | 105.189 | 1.244 | | | |
| 12 | 160.877 | 6.223 | 1.95906 | 17.5 | 0.6598 |
| 13 | −87.492 | 1.521 | 1.79952 | 42.2 | 0.5672 |
| 14 | 41.161 | d14 | | | |
| 15 | −47.635 | 1.615 | 1.61800 | 63.4 | 0.5441 |
| 16 | 19.338 | 3.423 | 1.80610 | 33.3 | 0.5883 |
| 17 | 41.155 | d17 | | | |
| 18 | ∞ | 1.000 | 1.51633 | 64.1 | 0.5353 |
| 19 | ∞ | 0.900 | | | |
| 20(Diaphragm) | ∞ | 2.200 | | | |
| 21 | 273.011 | 5.358 | 1.49700 | 81.6 | 0.5375 |
| 22 | −63.836 | 0.100 | | | |
| 23 | 64.502 | 7.466 | 1.43875 | 95.0 | 0.5340 |
| 24 | −47.586 | 2.424 | 1.80400 | 46.6 | 0.5573 |
| 25 | −117.919 | 0.200 | | | |
| 26 | 37.547 | 6.000 | 1.43875 | 95.0 | 0.5340 |
| 27 | 236.611 | 5.615 | | | |
| 28 | 79.896 | 2.424 | 1.77250 | 49.6 | 0.5520 |
| 29 | 33.393 | 3.818 | | | |
| 30 | 132.347 | 2.000 | 1.72916 | 54.7 | 0.5444 |
| 31 | 41.081 | 6.500 | 1.59522 | 67.7 | 0.5442 |
| 32 | −810.124 | 85.529 | | | |
| 33 | ∞ | 3.500 | 1.51680 | 64.2 | 0.5343 |
| 34 | ∞ | — | | | |

Optical Path Difference Function Coefficients for Diffraction
Surface DS

| | | |
|---|---|---|
| NO. 3 | P2 = −2.93073E−02 | P4 = 6.07486E−08 |

Partial Dispersion Ratio for Negative lens element 121

θ gF = 0.5883

TABLE 11
VARIOUS LENS SYSTEM DATA
Zoom Ratio: 101.19

| | Short Focal Length | Intermediate | Long Focal Length |
|---|---|---|---|
| | Extremity | Focal Length | Extremity |
| FNO. | 4.0 | 4.0 | 12.1 |
| f | 12.60 | 126.70 | 1275.00 |
| W | 20.8 | 2.0 | 0.2 |
| Y | 4.40 | 4.40 | 4.40 |
| fB | 1.00 | 1.00 | 1.00 |
| L | 403.09 | 403.09 | 403.09 |
| d9 | 4.517 | 124.968 | 149.245 |
| d14 | 138.459 | 17.043 | 55.474 |
| d17 | 63.767 | 64.732 | 2.024 |

Diffraction Surface Incidence Angle (°)

| | | |
|---|---|---|
| 11.74 | 0.27 | 0.05 |

TABLE 12
LENS GROUP DATA

| Lens Group | 1^{st} Surf. | Focal Length |
|---|---|---|
| 1 | 1 | 197.32 |
| 2 | 10 | −40.33 |
| 3 | 15 | −43.33 |
| 4 | 18 | 54.68 |

### Numerical Embodiment 5

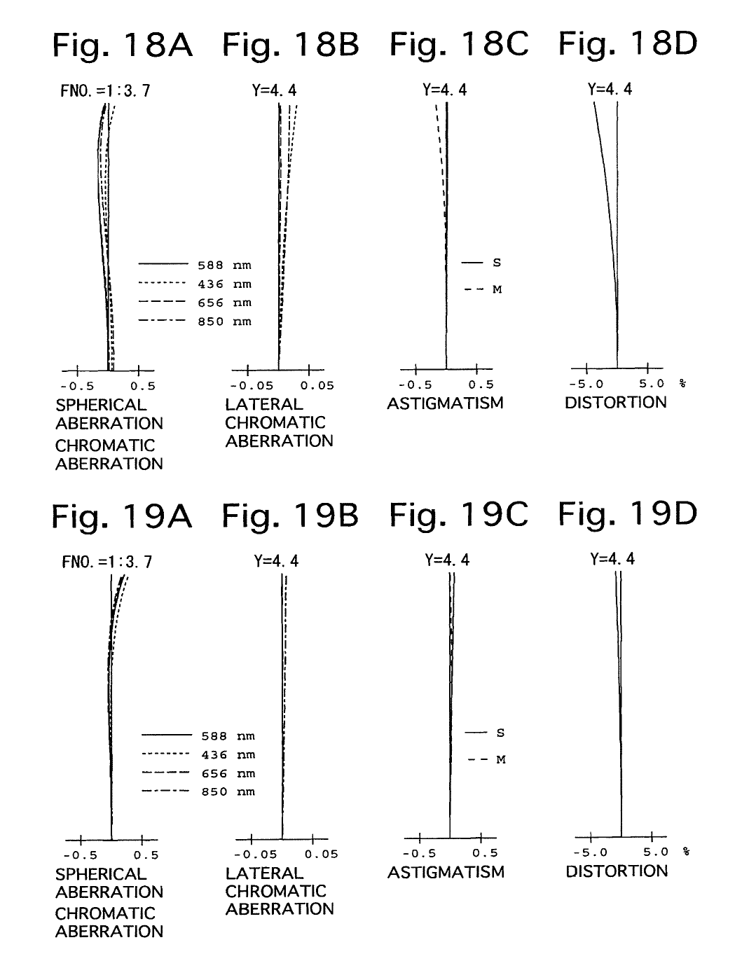

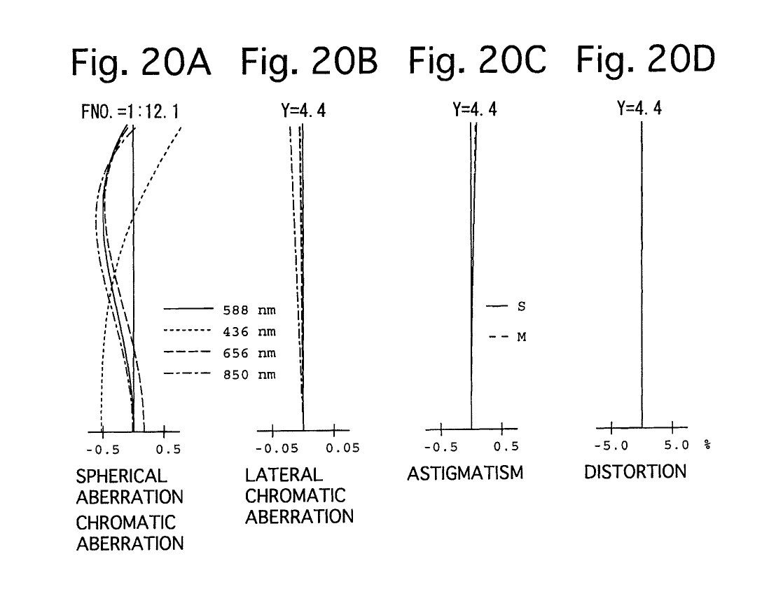

FIGS. 17 through 20 and Tables 13 through 15 show a fifth numerical embodiment of the zoom lens system according to the present invention. FIG. 17 shows the lens arrangement at the short focal length extremity when focused on an object at infinity. FIGS. 18, 19 and 20 show various aberration diagrams at the short focal length extremity, at an intermediate focal length and at the long focal length extremity, respectively, when focused on an object at infinity. Table 13 shows the lens surface data, Table 14 shows various lens-system data, and Table 15 shows the lens group data.

The lens arrangement of the fifth numerical embodiment is the same as that of the first numerical embodiment except for the following:

(1) The first lens group G1 is configured of a positive meniscus lens element 131 having a convex surface on the object side, a biconvex positive lens element 132, a positive meniscus lens element 133 having a convex surface on the object side, a positive meniscus lens element 134 having a convex surface on the object side, and a negative meniscus lens element 135 having a convex surface on the object side, in that order from the object side. The surface on the image side of the positive meniscus lens element 131 and the surface on the object side of the biconvex positive lens element 132 are cemented to each other, and the diffraction surface DS, which has a rotationally symmetric shape with respect to the optical axis, is formed on the cemented surface thereof.

(2) The fourth lens group G4 is configured of a biconvex positive lens element 431, a biconvex positive lens element 432, a biconvex positive lens element 433, a negative meniscus lens element 434 having a convex surface on the image side, a positive meniscus lens element 435 having a convex surface on the object side, a negative meniscus lens element 436 having a convex surface on the object side, and a biconvex positive lens element 437, in that order from the object side. The surface on the image side of the biconvex positive lens element 433 and the surface on the object side of the negative meniscus lens element 434 are cemented to each other.

TABLE 13
SURFACE DATA

| Surf. No. | R | d | N(d) | ν (d) | θ g F |
|---|---|---|---|---|---|
| 1 | 140.156 | 10.239 | 1.51633 | 64.1 | 0.5353 |
| 2 | 249.156 | 0.100 | 1.61505 | 26.5 | 0.6153 |
| 3* | 249.156 | 0.100 | 1.64310 | 38.8 | 0.5799 |
| 4 | 249.156 | 11.700 | 1.48749 | 70.2 | 0.5300 |
| 5 | −1952.193 | 0.200 | | | |
| 6 | 105.524 | 18.569 | 1.43875 | 95.0 | 0.5340 |
| 7 | 751.164 | 0.200 | | | |
| 8 | 86.578 | 16.823 | 1.43875 | 95.0 | 0.5340 |
| 9 | 901.830 | 0.898 | | | |
| 10 | 2113.286 | 3.500 | 1.80440 | 39.6 | 0.5729 |
| 11 | 85.931 | d11 | | | |
| 12 | −150.360 | 2.406 | 1.83400 | 37.2 | 0.5776 |
| 13 | 128.035 | 2.915 | | | |
| 14 | 188.504 | 6.223 | 1.92286 | 18.9 | 0.6495 |
| 15 | −59.693 | 1.521 | 1.79952 | 42.2 | 0.5672 |
| 16 | 39.466 | d16 | | | |
| 17 | −47.171 | 1.615 | 1.61800 | 63.4 | 0.5441 |
| 18 | 17.286 | 3.423 | 1.80610 | 33.3 | 0.5883 |
| 19 | 35.448 | d19 | | | |
| 20 | ∞ | 1.000 | 1.51633 | 64.1 | 0.5353 |
| 21 | ∞ | 0.900 | | | |
| 22(Diaphragm) | ∞ | 2.200 | | | |
| 23 | 83.109 | 5.358 | 1.49700 | 81.6 | 0.5375 |
| 24 | −89.484 | 0.100 | | | |
| 25 | 197.473 | 5.300 | 1.49700 | 81.6 | 0.5375 |
| 26 | −69.953 | 0.100 | | | |
| 27 | 105.698 | 7.466 | 1.43875 | 95.0 | 0.5340 |
| 28 | −42.842 | 2.424 | 1.80400 | 46.6 | 0.5573 |
| 29 | −441.050 | 0.200 | | | |
| 30 | 36.929 | 6.000 | 1.43875 | 95.0 | 0.5340 |
| 31 | 87.603 | 5.615 | | | |
| 32 | 172.522 | 2.424 | 1.77250 | 49.6 | 0.5520 |
| 33 | 38.879 | 77.114 | | | |
| 34 | 79.365 | 4.128 | 1.72916 | 54.7 | 0.5444 |
| 35 | −250.015 | 27.782 | | | |
| 36 | ∞ | 3.500 | 1.51680 | 64.2 | 0.5343 |
| 37 | ∞ | — | | | |

Optical Path Difference Function Coefficients for Diffraction
Surface DS

| | | |
|---|---|---|
| NO. 3 | P2 = −2.37752E−02 | P4 = 3.33275E−07 |

Partial Dispersion Ratio for Negative Lens Element 135

θ gF = 0.5729

TABLE 14
VARIOUS LENS SYSTEM DATA
Zoom Ratio: 57.95

| | Short Focal Length | Intermediate | Long Focal Length |
|---|---|---|---|
| | Extremity | Focal Length | Extremity |
| FNO. | 3.7 | 3.7 | 12.1 |
| f | 22.00 | 167.50 | 1275.00 |
| W | 11.7 | 1.5 | 0.2 |
| Y | 4.40 | 4.40 | 4.40 |
| fB | 1.00 | 1.00 | 1.00 |
| L | 383.60 | 383.60 | 383.60 |
| d11 | 5.515 | 82.738 | 97.471 |
| d16 | 78.600 | 5.460 | 50.118 |
| d19 | 66.444 | 62.361 | 2.971 |

Diffraction Surface Incidence Angle (°)

| | | |
|---|---|---|
| 12.52 | 5.13 | 0.14 |

TABLE 15
LENS GROUP DATA

| Lens Group | 1^{st} Surf. | Focal Length |
|---|---|---|
| 1 | 1 | 194.65 |
| 2 | 12 | −37.79 |
| 3 | 17 | −39.68 |
| 4 | 20 | 144.78 |

### Numerical Embodiment 6

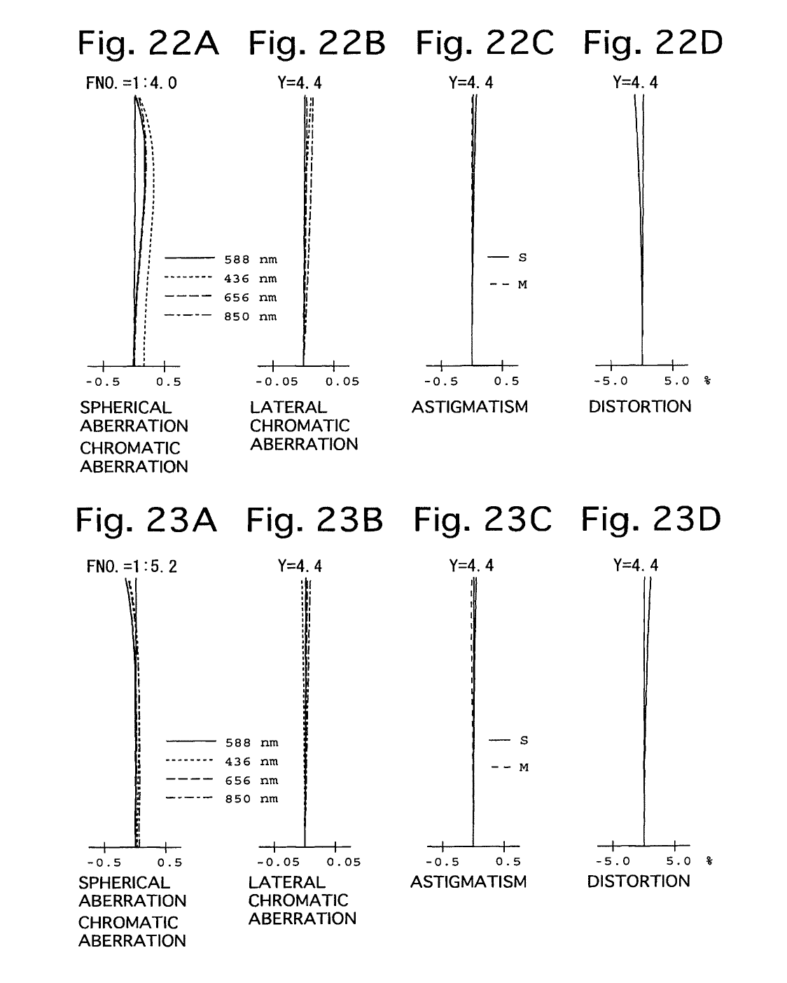

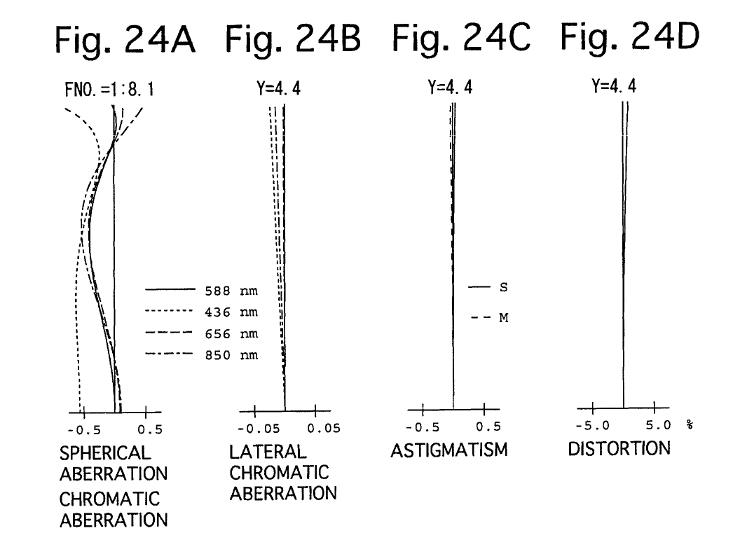

FIGS. 21 through 24 and Tables 16 through 18 show a sixth numerical embodiment of the zoom lens system according to the present invention. FIG. 21 shows the lens arrangement at the short focal length extremity when focused on an object at infinity. FIGS. 22, 23 and 24 show various aberration diagrams at the short focal length extremity, at an intermediate focal length and at the long focal length extremity, respectively, when focused on an object at infinity. Table 16 shows the lens surface data, Table 17 shows various lens-system data, and Table 18 shows the lens group data.

The lens arrangement of the sixth numerical embodiment differs overall from that of the first through fifth numerical embodiments.

(1) The zoom lens system is configured of a positive first lens group G1′, a negative second lens group G2′, a positive third lens group G3′ and a negative fourth lens group G4′, in that order from the object side (four lens groups constituting a positive-negative-positive-negative lens group configuration of a zoom lens system).

(2) The first lens group G1′ is configured of a negative meniscus lens element 141 having a convex surface on the object side, a biconvex positive lens element 142, a biconvex positive lens element 143, a negative meniscus lens element 144 having a convex surface on the image side, and a biconvex positive lens element 145, in that order from the object side. The surface on the image side of the negative meniscus lens element 141 and the surface on the object side of the biconvex positive lens element 142 are cemented to each other. The surface on the image side of the biconvex positive lens element 143 and the surface on the object side of the negative meniscus lens element 144 are cemented to each other, and the diffraction surface DS, which has a rotationally symmetric shape with respect to the optical axis, is formed on the cemented surface.

(3) The second lens group G2′ is configured of a negative meniscus lens element 211 having a convex surface on the object side, a biconvex positive lens element 212, a biconcave negative lens element 213, a positive meniscus lens element 214 having a convex surface on the image side, and a biconcave negative lens element 215, in that order from the object side. The surface on the image side of the biconvex positive lens element 212 and the surface on the object side of the biconcave negative lens element 213 are cemented to each other. The surface on the image side of the positive meniscus lens element 214 and the surface on the object side of the biconcave negative lens element 215 are cemented to each other.

(4) The third lens group G3′ is configured of a biconvex positive lens element 311, a negative meniscus lens element 312 having a convex surface on the object side, a biconvex positive lens element 313, and a positive meniscus lens element 314 having a convex surface on the object side, in that order from the object side. The surface on the image side of the negative meniscus lens element 312 and the surface on the object side of the biconvex positive lens element 313 are cemented to each other.

(5) The fourth lens group G4′ is configured of a positive meniscus lens element 441 having a convex surface on the object side, a positive meniscus lens element 442 having a convex surface on the object side, a biconcave negative lens element 443, a biconvex positive lens element 444, a biconvex positive lens element 445, and a biconcave negative lens element 446, in that order from the object side. The surface on the image side of the biconvex positive lens element 445 and the surface on the object side of the biconcave negative lens element 446 are cemented to each other.

(6) An aperture diaphragm S and an ND filter ND for light-quantity adjustment are provided, in that order from the object side, between the third lens group G3′ and the fourth lens group G4′ (immediately in front of the fourth lens group G4).

TABLE 16
SURFACE DATA

| Surf. No. | R | d | N(d) | ν (d) | θ g F |
|---|---|---|---|---|---|
| 1 | 479.909 | 3.100 | 2.00100 | 29.1 | 0.5994 |
| 2 | 113.923 | 17.305 | 1.61293 | 37.0 | 0.5849 |
| 3 | −10395.997 | 0.500 | | | |
| 4 | 623.352 | 15.390 | 1.43875 | 95.0 | 0.5340 |
| 5 | −188.916 | 0.100 | 1.64310 | 38.8 | 0.5799 |
| 6* | −188.916 | 0.100 | 1.61505 | 26.5 | 0.6153 |
| 7 | −188.916 | 3.200 | 1.45600 | 91.4 | 0.5342 |
| 8 | −421.984 | 0.200 | | | |
| 9 | 109.983 | 19.387 | 1.51633 | 64.1 | 0.5353 |
| 10 | −1324.776 | d10 | | | |
| 11 | 241.137 | 1.304 | 1.88300 | 40.8 | 0.5667 |
| 12 | 65.390 | 6.000 | | | |
| 13 | 71.470 | 4.303 | 1.84666 | 23.8 | 0.6205 |
| 14 | −62.894 | 1.700 | 1.80440 | 39.6 | 0.5729 |
| 15 | 41.260 | 4.174 | | | |
| 16 | −38.191 | 3.214 | 1.80810 | 22.8 | 0.6307 |
| 17 | −26.595 | 1.200 | 1.69350 | 53.2 | 0.5473 |
| 18 | 3739.624 | d18 | | | |
| 19 | 87.056 | 4.856 | 1.49700 | 81.6 | 0.5375 |
| 20 | −105.693 | 0.120 | | | |
| 21 | 86.016 | 2.791 | 1.83400 | 37.3 | 0.5789 |
| 22 | 40.082 | 5.792 | 1.43875 | 95.0 | 0.5340 |
| 23 | −1337.427 | 0.120 | | | |
| 24 | 78.564 | 4.266 | 1.49700 | 81.6 | 0.5375 |
| 25 | 219.099 | d25 | | | |
| 26(Diaphragm) | ∞ | 0.600 | | | |
| 27 | ∞ | 1.000 | 1.51680 | 64.2 | 0.5343 |
| 28 | ∞ | 1.033 | | | |
| 29 | 47.481 | 2.891 | 1.80440 | 39.6 | 0.5729 |
| 30 | 64.977 | 1.782 | | | |
| 31 | 23.875 | 3.829 | 1.43875 | 95.0 | 0.5340 |
| 32 | 47.049 | 1.708 | | | |
| 33 | −383.102 | 1.200 | 1.72916 | 54.7 | 0.5444 |
| 34 | 28.455 | 26.195 | | | |
| 35 | 158.309 | 3.821 | 1.88300 | 40.8 | 0.5667 |
| 36 | −35.161 | 0.532 | | | |
| 37 | 29.791 | 4.660 | 1.49700 | 81.6 | 0.5375 |
| 38 | −22.176 | 1.200 | 1.77250 | 49.6 | 0.5520 |
| 39 | 20.632 | 36.857 | | | |
| 40 | ∞ | 3.500 | 1.51633 | 64.1 | 0.5353 |
| 41 | ∞ | — | | | |

Optical Path Difference Function Coefficients for Diffraction
Surface DS

| | | |
|---|---|---|
| NO. 6 | P2 = −3.24379E−02 | P4 = −7.15880E−07 |

Partial Dispersion Ratio for Negative Lens Element 144

θ gF = 0.5342

TABLE 17
VARIOUS LENS SYSTEM DATA
Zoom Ratio: 51.52

| | Short Focal Length | Intermediate | Long Focal Length |
|---|---|---|---|
| | Extremity | Focal Length | Extremity |
| FNO. | 4.0 | 5.2 | 8.1 |
| f | 16.50 | 118.40 | 850.00 |
| W | 15.1 | 2.1 | 0.3 |
| Y | 4.40 | 4.40 | 4.40 |
| fB | 1.00 | 1.00 | 1.00 |
| L | 414.39 | 414.39 | 414.39 |
| d10 | 4.598 | 91.625 | 118.420 |
| d18 | 215.004 | 97.816 | 5.118 |
| d25 | 3.856 | 34.017 | 99.920 |

Diffraction Surface Incidence Angle (°)

| | | |
|---|---|---|
| 7.88 | 0.10 | 0.10 |

TABLE 18
LENS GROUP DATA

| Lens Group | 1^{st} Surf. | Focal Length |
|---|---|---|
| 1 | 1 | 176.64 |
| 2 | 11 | −27.98 |
| 3 | 19 | 68.76 |
| 4 | 26 | −214.82 |

### Numerical Embodiment 7

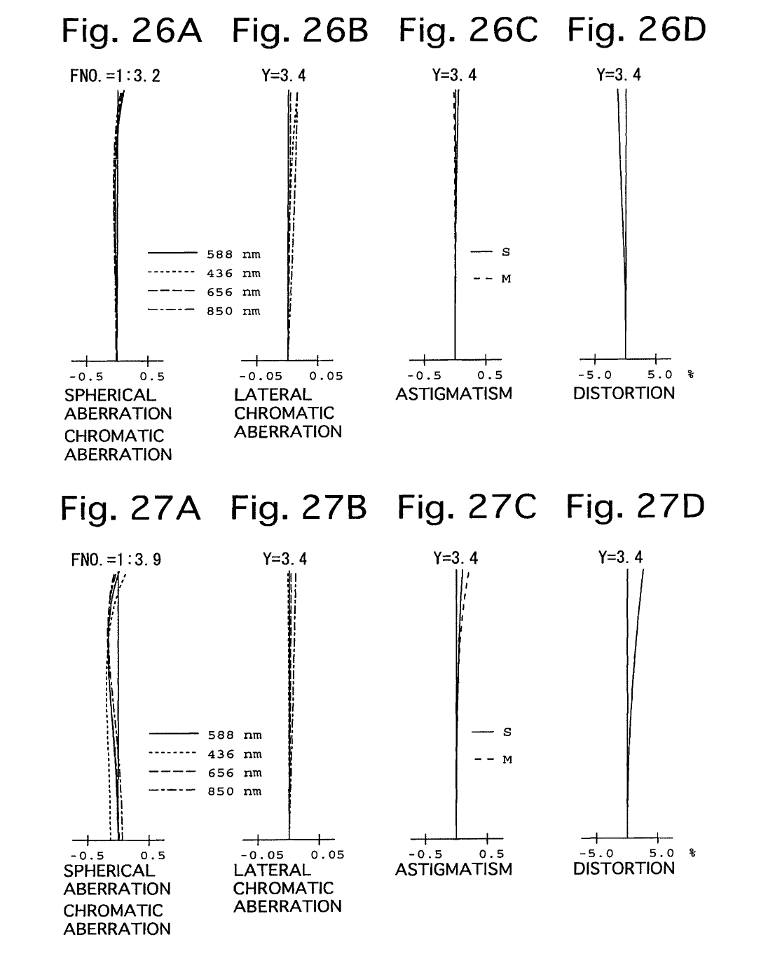

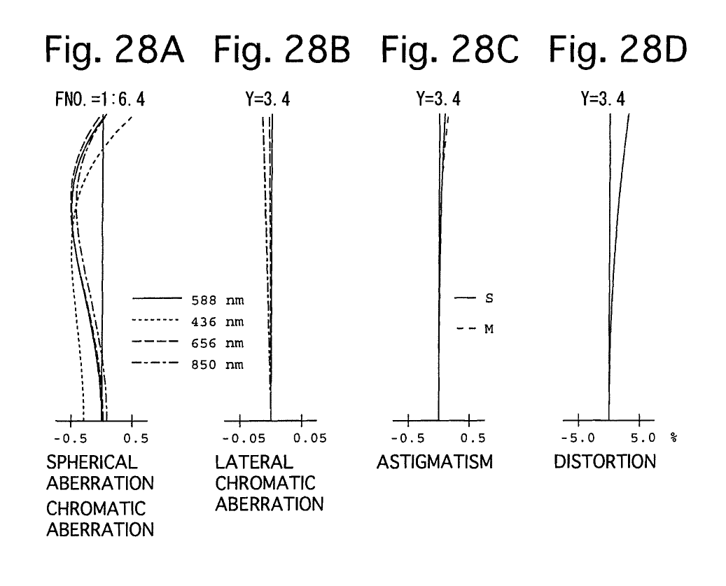

FIGS. 25 through 28 and Tables 19 through 21 show a seventh numerical embodiment of the zoom lens system according to the present invention. FIG. 25 shows the lens arrangement at the short focal length extremity when focused on an object at infinity. FIGS. 26, 27 and 28 show various aberration diagrams at the short focal length extremity, at an intermediate focal length and at the long focal length extremity, respectively, when focused on an object at infinity. Table 19 shows the lens surface data, Table 20 shows various lens-system data, and Table 21 shows the lens group data.

The lens arrangement of the seventh numerical embodiment differs overall from that of the first through sixth numerical embodiments.

(1) The zoom lens system is configured of a positive first lens group G1″, a negative second lens group G2″, a positive third lens group G3″, a negative fourth lens group G4″ and a positive fifth lens group G5″, in that order from the object side (five lens groups constituting a positive-negative-positive-negative-positive lens group configuration of a zoom lens system).

(2) The first lens group G1″ is configured of a negative meniscus lens element 151 having a convex surface on the object side, a biconvex positive lens element 152, and a positive meniscus lens element 153 having a convex surface on the object side, in that order from the object side. The surface on the image side of the negative meniscus lens element 151 and the surface on the object side of the biconvex positive lens element 152 are cemented to each other, and the diffraction surface DS, which has a rotationally symmetric shape with respect to the optical axis, is formed on the cemented surface thereof.

(3) The second lens group G2″ is configured of a negative meniscus lens element 221 having a convex surface on the object side, a negative meniscus lens element 222 having a convex surface on the image side, a biconvex positive lens element 223, and a biconcave negative lens element 224, in that order from the object side. The surface on the image side of the biconvex positive lens element 223 and the surface on the object side of the biconcave negative lens element 224 are cemented to each other.

(4) The third lens group G3″ is configured of a biconvex positive lens element 321, a biconvex positive lens element 322, and a negative meniscus lens element 323 having a convex surface on the image side, in that order from the object side. The surface on the image side of the biconvex positive lens element 322 and the surface on the object side of the negative meniscus lens element 323 are cemented to each other.

(5) The fourth lens group G4″ is configured of a positive meniscus lens element 451 having a convex surface on the image side, and a biconcave negative lens element 452, in that order from the object side. The surface on the image side of the positive meniscus lens element 451 and the surface on the object side of the biconcave negative lens element 452 are cemented to each other.

(6) The fifth lens group G5″ is configured of a biconvex positive lens element 501, a negative meniscus lens element 502 having a convex surface on the object side, and a positive meniscus lens element 503 having a convex surface on the object side, in that order from the object side.

(7) An ND filter ND for light-quantity adjustment and an aperture diaphragm S are provided, in that order from the object side, between the second lens group G2″ and the third lens group G3″ (immediately in front of the third lens group G3″).

TABLE 19
SURFACE DATA

| Surf. No. | R | d | N(d) | ν (d) | θ g F |
|---|---|---|---|---|---|
| 1 | 158.591 | 2.000 | 1.80400 | 46.6 | 0.5573 |
| 2 | 72.113 | 0.100 | 1.61505 | 26.5 | 0.6153 |
| 3* | 72.113 | 0.100 | 1.64310 | 38.8 | 0.5799 |
| 4 | 72.113 | 12.460 | 1.43875 | 95.0 | 0.5340 |
| 5 | −276.991 | 0.432 | | | |
| 6 | 65.970 | 9.906 | 1.43875 | 95.0 | 0.5340 |
| 7 | 843.383 | d7 | | | |
| 8 | 91.741 | 1.458 | 1.83400 | 37.2 | 0.5776 |
| 9 | 15.890 | 4.198 | | | |
| 10 | −23.106 | 1.458 | 1.83400 | 37.2 | 0.5776 |
| 11 | −283.908 | 2.000 | | | |
| 12 | 49.874 | 5.562 | 1.92286 | 18.9 | 0.6495 |
| 13 | −38.997 | 2.000 | 1.88300 | 40.8 | 0.5667 |
| 14 | 91.709 | d14 | | | |
| 15 | ∞ | 1.000 | 1.51633 | 64.1 | 0.5353 |
| 16 | ∞ | 2.500 | | | |
| 17(Diaphragm) | ∞ | 1.296 | | | |
| 18 | 63.212 | 4.857 | 1.43875 | 95.0 | 0.5340 |
| 19 | −33.118 | 0.119 | | | |
| 20 | 36.198 | 6.966 | 1.49700 | 81.6 | 0.5375 |
| 21 | −23.711 | 1.458 | 1.80610 | 33.3 | 0.5883 |
| 22 | −61.573 | d22 | | | |
| 23 | −53.009 | 5.821 | 1.92286 | 18.9 | 0.6495 |
| 24 | −20.981 | 1.500 | 1.83400 | 37.2 | 0.5776 |
| 25 | 73.636 | d25 | | | |
| 26 | 50.923 | 2.970 | 1.56908 | 71.3 | 0.5450 |
| 27 | −25.444 | 0.419 | | | |
| 28 | 32.163 | 1.782 | 1.64769 | 33.8 | 0.5938 |
| 29 | 8.910 | 0.672 | | | |
| 30 | 12.816 | 4.050 | 1.77250 | 49.6 | 0.5520 |
| 31 | 25.201 | 11.200 | | | |
| 32 | ∞ | 5.616 | 1.51633 | 64.1 | 0.5353 |
| 33 | ∞ | — | | | |

Optical Path Difference Function Coefficients for Diffraction
Surface DS

| | | |
|---|---|---|
| NO. 3 | P2 = −1.02441E−02 | P4 = 3.22386E−06 |

Partial Dispersion Ratio for Negative Lens Element 151

θ gF = 0.5573

TABLE 20
VARIOUS LENS SYSTEM DATA
Zoom Ratio: 52.50

| | Short Focal Length | Intermediate | Long Focal Length |
|---|---|---|---|
| | Extremity | Focal Length | Extremity |
| FNO. | 3.2 | 3.9 | 6.4 |
| f | 8.00 | 58.00 | 420.00 |
| W | 23.3 | 3.3 | 0.4 |
| Y | 3.40 | 3.40 | 3.40 |
| fB | 1.00 | 1.00 | 1.00 |
| L | 237.40 | 237.40 | 237.40 |
| d7 | 2.900 | 73.521 | 102.935 |
| d14 | 105.920 | 35.299 | 5.885 |
| d22 | 5.629 | 20.917 | 2.960 |
| d25 | 28.053 | 12.766 | 30.722 |

Diffraction Surface Incidence Angle (°)

| | | |
|---|---|---|
| 15.97 | 3.91 | 0.28 |

TABLE 21
LENS GROUP DATA

| Lens Group | 1^{st} Surf. | Focal Length |
|---|---|---|
| 1 | 1 | 129.25 |
| 2 | 8 | −14.33 |
| 3 | 15 | 30.25 |
| 4 | 23 | −40.01 |
| 5 | 26 | 60.31 |

### Numerical Embodiment 8

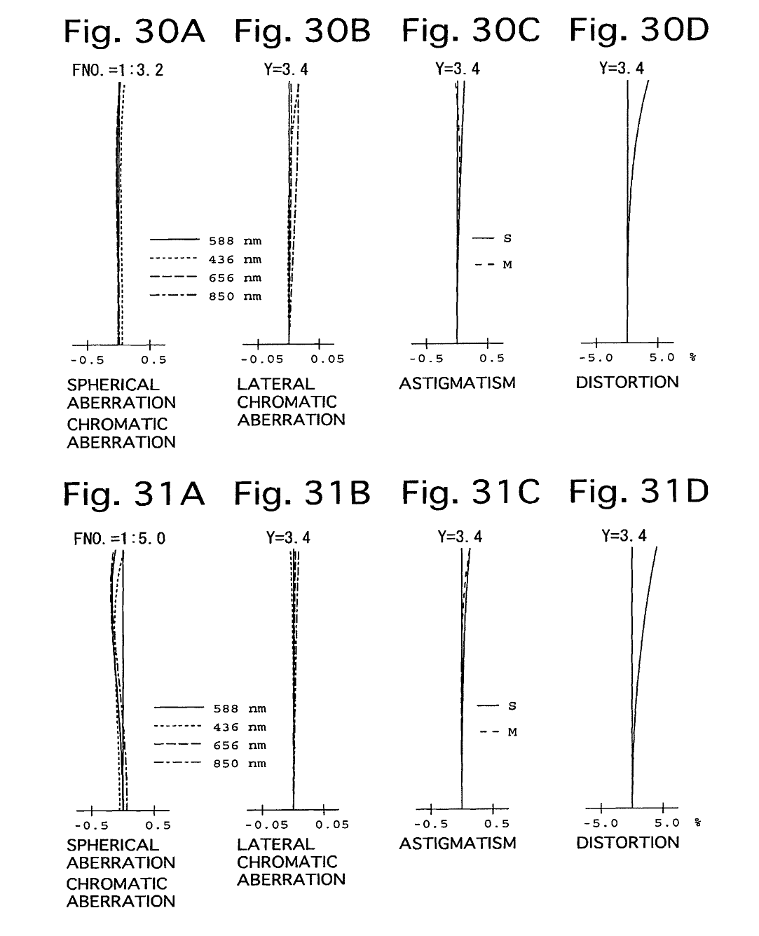

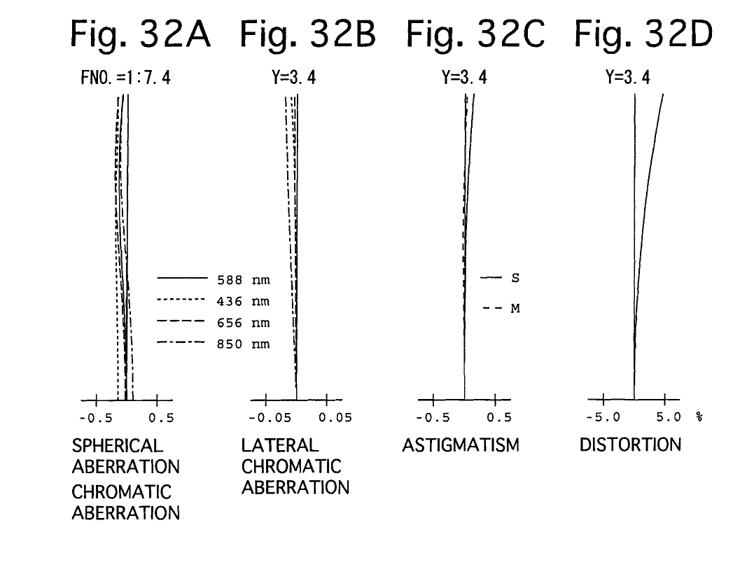

FIGS. 29 through 32 and Tables 22 through 24 show an eighth numerical embodiment of the zoom lens system according to the present invention. FIG. 29 shows the lens arrangement at the short focal length extremity when focused on an object at infinity. FIGS. 30, 31 and 32 show various aberration diagrams at the short focal length extremity, at an intermediate focal length and at the long focal length extremity, respectively, when focused on an object at infinity. Table 22 shows the lens surface data, Table 23 shows various lens-system data, and Table 24 shows the lens group data.

The lens arrangement of the eighth numerical embodiment is the same as that of the seventh numerical embodiment except for the following:

(1) In the second lens group G2″, the negative lens element 222 is configured of a biconcave negative lens element, the positive lens element 223 is configured of a positive meniscus lens element having convex surface on the object side, and the negative lens element 224 is configured of a negative meniscus lens element having a convex surface on the object side.

(2) The negative lens element 452 of the fourth lens group G4″ is configured of a negative meniscus lens element having a convex surface on the image side.

(3) The fifth lens group G5″ is configured of a biconvex positive lens element 511 and a negative meniscus lens element 512 having a convex surface on the object side, in that order from the object side.

TABLE 22
SURFACE DATA

| Surf. No. | R | d | N(d) | ν (d) | θ g F |
|---|---|---|---|---|---|
| 1 | 135.941 | 2.000 | 1.80610 | 40.9 | 0.5701 |
| 2 | 63.371 | 0.100 | 1.61505 | 26.5 | 0.6153 |
| 3* | 63.371 | 0.100 | 1.64310 | 38.8 | 0.5799 |
| 4 | 63.371 | 12.460 | 1.49700 | 81.6 | 0.5375 |
| 5 | −981.982 | 0.432 | | | |
| 6 | 61.493 | 9.906 | 1.49700 | 81.6 | 0.5375 |
| 7 | 262.222 | d7 | | | |
| 8 | 50.988 | 1.458 | 1.80400 | 46.6 | 0.5573 |
| 9 | 12.975 | 4.198 | | | |
| 10 | −37.569 | 1.458 | 1.80400 | 46.6 | 0.5573 |
| 11 | 57.046 | 2.000 | | | |
| 12 | 23.701 | 5.562 | 1.95906 | 17.5 | 0.6598 |
| 13 | 98.949 | 2.000 | 1.85026 | 32.3 | 0.5929 |
| 14 | 28.764 | d14 | | | |
| 15 | ∞ | 1.000 | 1.51633 | 64.1 | 0.5353 |
| 16 | ∞ | 2.500 | | | |
| 17(Diaphragm) | ∞ | 1.296 | | | |
| 18 | 46.844 | 3.442 | 1.43875 | 95.0 | 0.5340 |
| 19 | −29.933 | 0.119 | | | |
| 20 | 48.245 | 3.488 | 1.49700 | 81.6 | 0.5375 |
| 21 | −19.939 | 1.458 | 1.80610 | 33.3 | 0.5883 |
| 22 | −40.859 | d22 | | | |
| 23 | −22.246 | 2.502 | 1.92286 | 18.9 | 0.6495 |
| 24 | −16.663 | 1.500 | 1.80440 | 39.6 | 0.5729 |
| 25 | −65.957 | d25 | | | |
| 26 | 14.321 | 2.970 | 1.56908 | 71.3 | 0.5450 |
| 27 | −41.609 | 0.419 | | | |
| 28 | 9.498 | 1.782 | 1.83400 | 37.2 | 0.5776 |
| 29 | 5.218 | 12.595 | | | |
| 30 | ∞ | 3.500 | 1.51633 | 64.1 | 0.5353 |
| 31 | ∞ | — | | | |

Optical Path Difference Function Coefficients for Diffraction
Surface DS

| | | |
|---|---|---|
| NO. 3 | P2 = −9.58436E−03 | P4 = 4.14533E−07 |

Partial Dispersion Ratio for Negative Lens Element 151

θ gF = 0.5701

TABLE 23
VARIOUS LENS SYSTEM DATA
Zoom Ratio: 66.41

| | Short Focal Length | Intermediate | Long Focal Length |
|---|---|---|---|
| | Extremity | Focal Length | Extremity |
| FNO. | 3.2 | 5.0 | 7.4 |
| f | 6.40 | 59.40 | 425.00 |
| W | 27.2 | 3.1 | 0.4 |
| Y | 3.40 | 3.40 | 3.40 |
| fB | 1.00 | 1.00 | 1.00 |
| L | 199.90 | 219.81 | 250.62 |
| d7 | 2.603 | 68.662 | 93.662 |
| d14 | 94.393 | 28.336 | 3.298 |
| d22 | 7.537 | 20.266 | 24.892 |
| d25 | 14.116 | 21.298 | 47.518 |

Diffraction Surface Incidence Angle (°)

| | | |
|---|---|---|
| 19.10 | 4.22 | 0.94 |

TABLE 24
LENS GROUP DATA

| Lens Group | 1^{st} Surf. | Focal Length |
|---|---|---|
| 1 | 1 | 128.25 |
| 2 | 8 | −12.83 |
| 3 | 15 | 26.88 |
| 4 | 23 | −48.09 |
| 5 | 26 | 128.00 |

### Numerical Embodiment 9

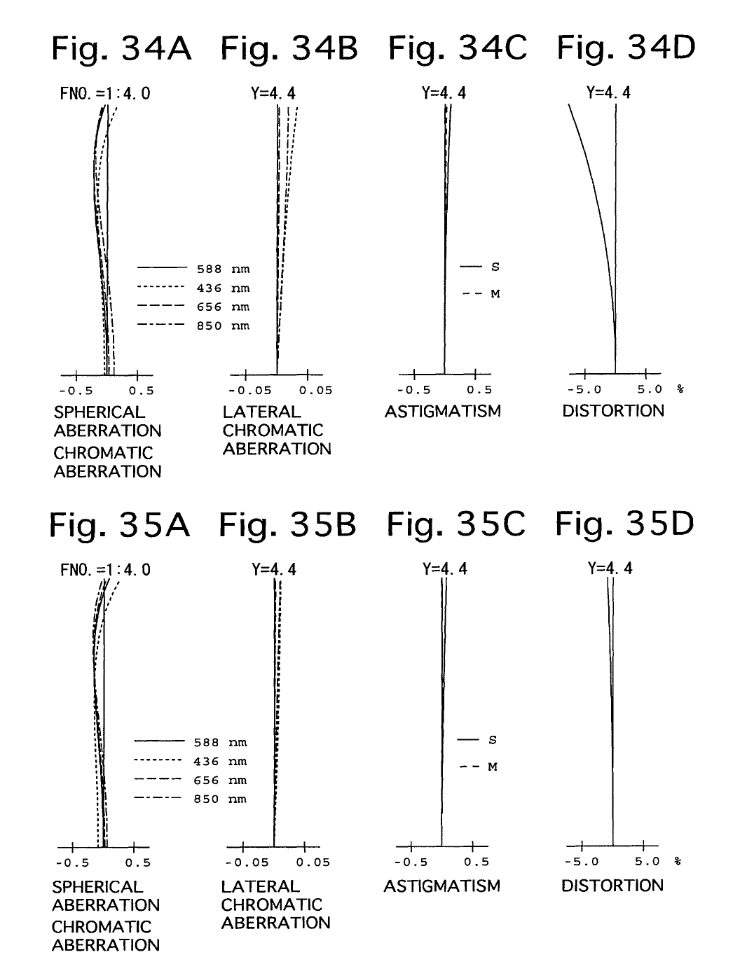

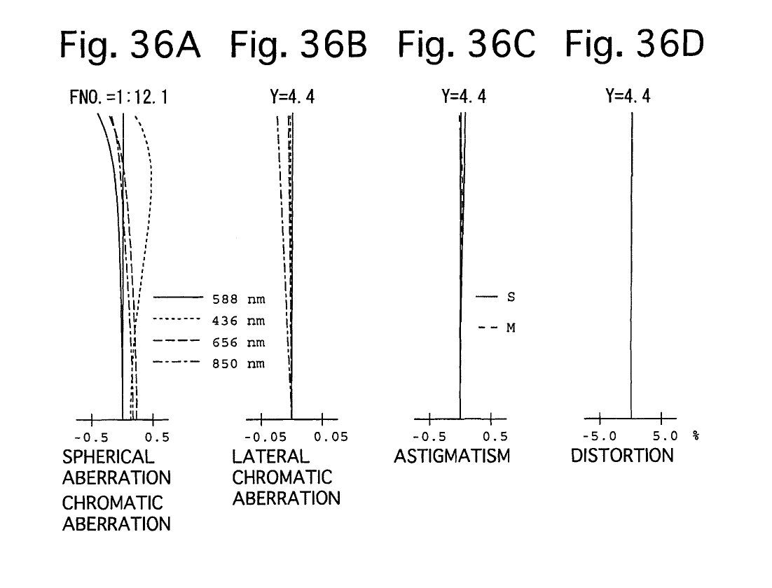

FIGS. 33 through 36 and Tables 25 through 27 show a ninth numerical embodiment of the zoom lens system according to the present invention. FIG. 33 shows the lens arrangement at the short focal length extremity when focused on an object at infinity. FIGS. 34, 35 and 36 show various aberration diagrams at the short focal length extremity, at an intermediate focal length and at the long focal length extremity, respectively, when focused on an object at infinity. Table 25 shows the lens surface data, Table 26 shows various lens-system data, and Table 27 shows the lens group data.

The lens arrangement of the ninth numerical embodiment is the same as that of the fourth numerical embodiment.

TABLE 25
SURFACE DATA

| Surf. No. | R | d | N(d) | ν (d) | θ g F |
|---|---|---|---|---|---|
| 1 | 780.971 | 3.500 | 1.83400 | 37.3 | 0.5789 |
| 2 | 161.512 | 0.100 | 1.64310 | 38.8 | 0.5799 |
| 3* | 161.512 | 0.100 | 1.61505 | 26.5 | 0.6153 |
| 4 | 161.512 | 16.401 | 1.49700 | 81.6 | 0.5375 |
| 5 | −470.007 | 0.200 | | | |
| 6 | 148.552 | 13.241 | 1.49700 | 81.6 | 0.5375 |
| 7 | 393.615 | 0.200 | | | |
| 8 | 133.838 | 10.144 | 1.51633 | 64.1 | 0.5353 |
| 9 | 524.900 | d9 | | | |
| 10 | −185.266 | 2.406 | 1.83400 | 37.2 | 0.5776 |
| 11 | 105.189 | 1.244 | | | |
| 12 | 160.877 | 6.223 | 1.95906 | 17.5 | 0.6598 |
| 13 | −87.492 | 1.521 | 1.79952 | 42.2 | 0.5672 |
| 14 | 41.161 | d14 | | | |
| 15 | −47.635 | 1.615 | 1.61800 | 63.4 | 0.5441 |
| 16 | 19.338 | 3.423 | 1.80610 | 33.3 | 0.5883 |
| 17 | 41.155 | d17 | | | |
| 18 | ∞ | 1.000 | 1.51633 | 64.1 | 0.5353 |
| 19 | ∞ | 0.900 | | | |
| 20(Diaphragm) | ∞ | 2.200 | | | |
| 21 | 273.011 | 5.358 | 1.49700 | 81.6 | 0.5375 |
| 22 | −63.836 | 0.100 | | | |
| 23 | 64.502 | 7.466 | 1.43875 | 95.0 | 0.5340 |
| 24 | −47.586 | 2.424 | 1.80400 | 46.6 | 0.5573 |
| 25 | −117.919 | 0.200 | | | |
| 26 | 37.547 | 6.000 | 1.43875 | 95.0 | 0.5340 |
| 27 | 236.611 | 5.615 | | | |
| 28 | 79.896 | 2.424 | 1.77250 | 49.6 | 0.5520 |
| 29 | 33.393 | 3.818 | | | |
| 30 | 132.347 | 2.000 | 1.72916 | 54.7 | 0.5444 |
| 31 | 41.081 | 6.500 | 1.59522 | 67.7 | 0.5442 |
| 32 | −810.124 | 85.529 | | | |
| 33 | ∞ | 3.500 | 1.51680 | 64.2 | 0.5343 |
| 34 | ∞ | — | | | |

Optical Path Difference Function Coefficients for Diffraction
Surface DS

| | | |
|---|---|---|
| NO. 3 | P2 = −2.21152E−02 | P4 = −4.77057E−08 |

Partial Dispersion Ratio for Negative Lens Element 121

θ gF = 0.5789

TABLE 26
VARIOUS LENS SYSTEM DATA
Zoom Ratio: 99.61

| | Short Focal Length | Intermediate | Long Focal Length |
|---|---|---|---|
| | Extremity | Focal Length | Extremity |
| FNO. | 4.0 | 4.0 | 12.1 |
| f | 12.80 | 108.00 | 1275.00 |
| W | 20.4 | 2.4 | 0.2 |
| Y | 4.40 | 4.40 | 4.40 |
| fB | 1.00 | 1.00 | 1.00 |
| L | 403.18 | 403.18 | 403.18 |
| d9 | 5.982 | 120.422 | 149.326 |
| d14 | 137.032 | 20.669 | 55.474 |
| d17 | 63.810 | 65.733 | 2.024 |

Diffraction Surface Incidence Angle (°)

| | | |
|---|---|---|
| 12.22 | 1.29 | 0.11 |

TABLE 27
LENS GROUP DATA

| Lens Group | 1^{st} Surf. | Focal Length |
|---|---|---|
| 1 | 1 | 197.32 |
| 2 | 10 | −40.33 |
| 3 | 15 | −43.33 |
| 4 | 18 | 54.68 |

### Numerical Embodiment 10

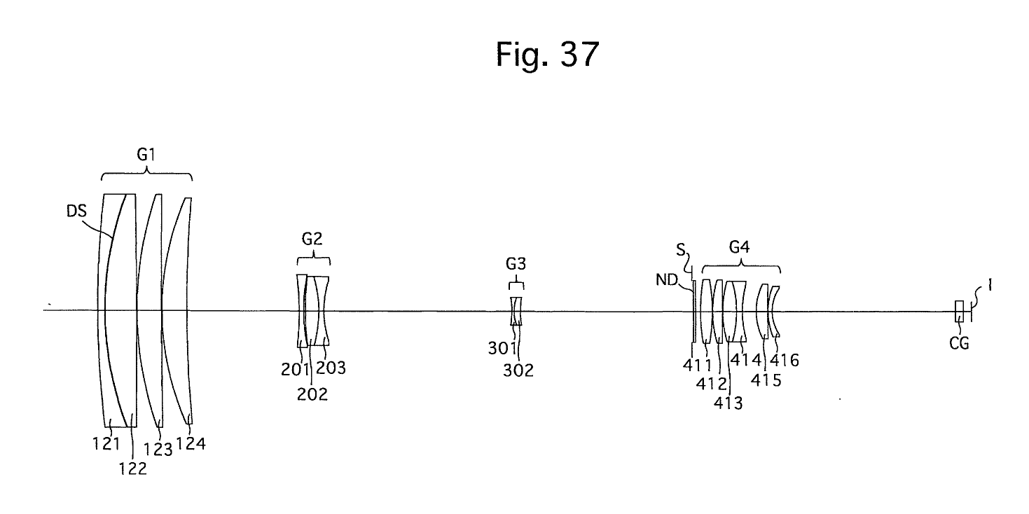

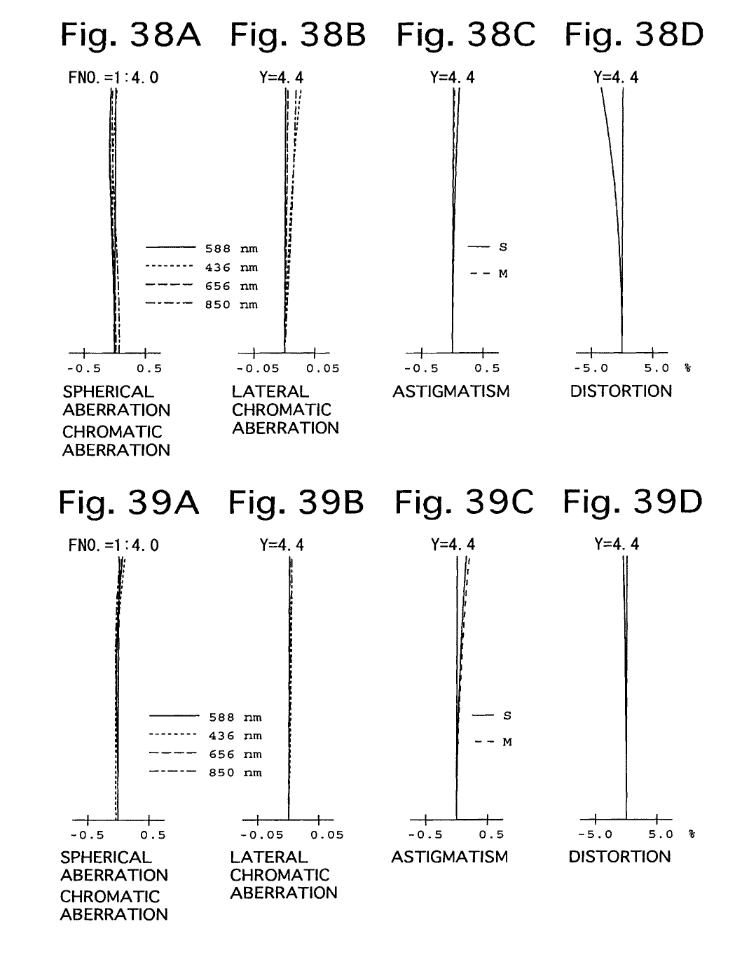

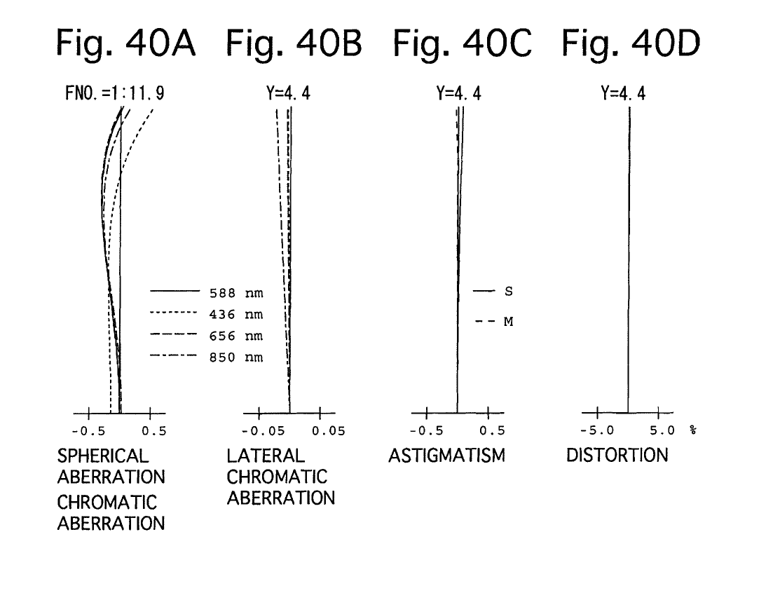

FIGS. 37 through 40 and Tables 28 through 30 show a tenth numerical embodiment of the zoom lens system according to the present invention. FIG. 37 shows the lens arrangement at the short focal length extremity when focused on an object at infinity. FIGS. 38, 39 and 40 show various aberration diagrams at the short focal length extremity, at an intermediate focal length and at the long focal length extremity, respectively, when focused on an object at infinity. Table 28 shows the lens surface data, Table 29 shows various lens-system data, and Table 30 shows the lens group data.

The lens arrangement of the tenth numerical embodiment is the same as that of the third numerical embodiment except for the following:

(1) The negative lens element 121 of the first lens group G1 is not a biconcave negative lens element, but rather a negative meniscus lens element having a convex surface on the object side.

TABLE 28
SURFACE DATA

| Surf. No. | R | d | N(d) | ν (d) | θ g F |
|---|---|---|---|---|---|
| 1 | 456.906 | 3.168 | 1.80440 | 39.6 | 0.5729 |
| 2 | 144.518 | 0.100 | 1.64310 | 38.8 | 0.5799 |
| 3* | 144.518 | 0.100 | 1.61505 | 26.5 | 0.6153 |
| 4 | 144.518 | 14.430 | 1.48749 | 70.2 | 0.5300 |
| 5 | −3656.683 | 0.200 | | | |
| 6 | 161.860 | 11.059 | 1.43875 | 95.0 | 0.5340 |
| 7 | 4948.334 | 0.200 | | | |
| 8 | 123.760 | 11.450 | 1.43875 | 95.0 | 0.5340 |
| 9 | 581.971 | d9 | | | |
| 10 | −149.581 | 2.000 | 1.74950 | 35.3 | 0.5869 |
| 11 | 78.458 | 0.780 | | | |
| 12 | 130.245 | 6.000 | 1.92286 | 18.9 | 0.6495 |
| 13 | −57.620 | 2.240 | 1.83400 | 37.2 | 0.5776 |
| 14 | 45.962 | d14 | | | |
| 15 | −45.852 | 1.000 | 1.61800 | 63.4 | 0.5441 |
| 16 | 18.400 | 2.804 | 1.80610 | 33.3 | 0.5883 |
| 17 | 39.732 | d17 | | | |
| 18(Diaphragm) | ∞ | 0.600 | | | |
| 19 | ∞ | 1.000 | 1.51633 | 64.1 | 0.5353 |
| 20 | ∞ | 2.200 | | | |
| 21 | 85.714 | 5.275 | 1.43875 | 95.0 | 0.5340 |
| 22 | −84.923 | 0.100 | | | |
| 23 | 51.387 | 4.397 | 1.43875 | 95.0 | 0.5340 |
| 24 | −1122.681 | 0.100 | | | |
| 25 | 49.896 | 6.199 | 1.49700 | 81.6 | 0.5375 |
| 26 | −49.463 | 2.588 | 1.77250 | 49.6 | 0.5520 |
| 27 | 49.938 | 6.185 | | | |
| 28 | 28.740 | 5.198 | 1.61800 | 63.4 | 0.5441 |
| 29 | 677.918 | 0.100 | | | |
| 30 | 32.577 | 1.800 | 1.69680 | 55.5 | 0.5434 |
| 31 | 18.949 | 82.106 | | | |
| 32 | ∞ | 3.500 | 1.51633 | 64.1 | 0.5353 |
| 33 | ∞ | — | | | |

Optical Path Difference Function Coefficients for Diffraction
Surface DS

| | | |
|---|---|---|
| NO. 3 | P2 = −1.95080E−02 | P4 = −3.68543E−09 |

Partial Dispersion Ratio for Negative Lens Element 121

θ gF = 0.5729

TABLE 29
VARIOUS LENS SYSTEM DATA
Zoom Ratio: 62.50

| | Short Focal Length | Intermediate | Long Focal Length |
|---|---|---|---|
| | Extremity | Focal Length | Extremity |
| FNO. | 4.0 | 4.0 | 11.9 |
| f | 20.00 | 158.00 | 1250.00 |
| W | 12.8 | 1.6 | 0.2 |
| Y | 4.40 | 4.40 | 4.40 |
| fB | 1.00 | 1.00 | 1.00 |
| L | 389.49 | 389.49 | 389.49 |
| d9 | 50.617 | 132.857 | 147.107 |
| d14 | 84.219 | 7.187 | 60.038 |
| d17 | 76.778 | 71.570 | 4.469 |

Diffraction Surface Incidence Angle (°)

| | | |
|---|---|---|
| 8.93 | 1.72 | 0.12 |

TABLE 30
LENS GROUP DATA

| Lens Group | 1^{st} Surf. | Focal Length |
|---|---|---|
| 1 | 1 | 194.88 |
| 2 | 10 | −40.30 |
| 3 | 15 | −42.14 |
| 4 | 18 | 54.66 |

### Reference Example

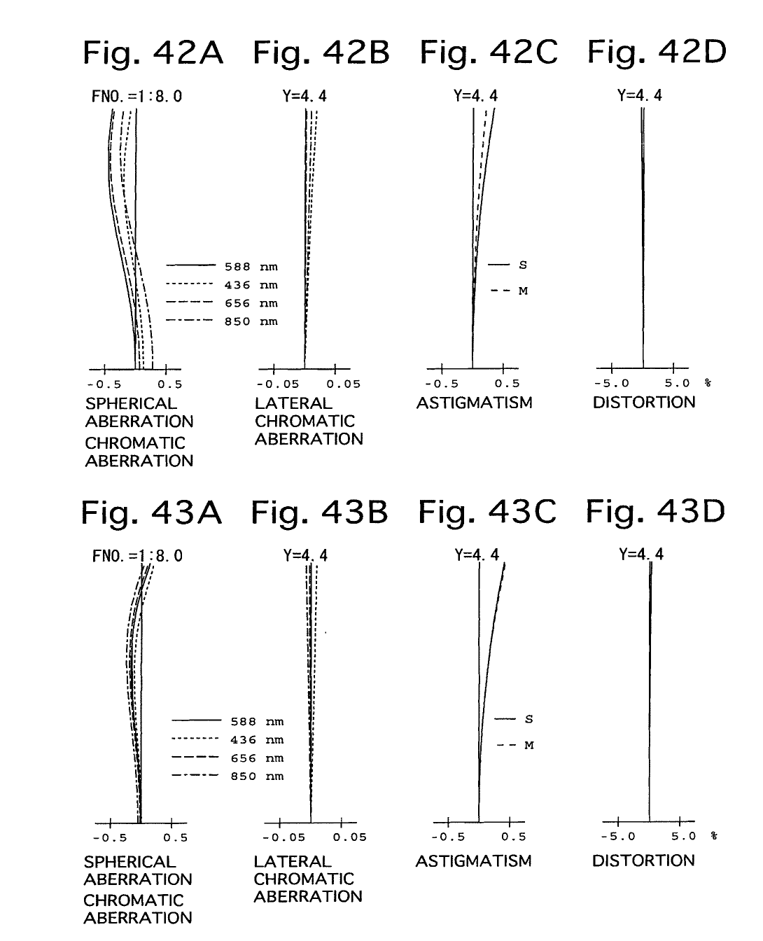

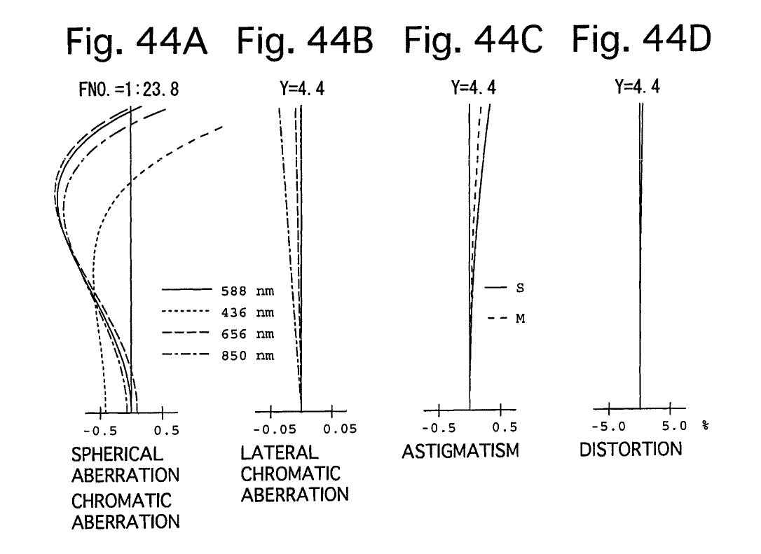

FIGS. 41 through 44 and Tables 31 through 33 show a reference example of the zoom lens system according to the above-described first through tenth numerical embodiments of the present invention. FIG. 41 shows the lens arrangement at the short focal length extremity when focused on an object at infinity. FIGS. 42, 43 and 44 show various aberration diagrams at the short focal length extremity, at an intermediate focal length and at the long focal length extremity, respectively, when focused on an object at infinity. Table 31 shows the lens surface data, Table 32 shows various lens-system data, and Table 33 shows the lens group data.

The lens arrangement of this reference example includes an extender (rear converter) EX, for changing the focal length of the entire lens system (e.g., doubling the focal length) toward the long focal length side, provided in optical path between the fourth lens group G4 and the cover glass CG, with respect to the lens arrangement of the tenth numerical embodiment. The extender EX is insertable into the optical path between the fourth lens group G4 and the cover glass CG. The extender EX is configured of a positive meniscus lens element EX1 having a convex surface on the object side, a cemented lens configured of a biconvex positive lens element EX2 and a biconcave negative lens element EX3, and a cemented lens configured of a positive meniscus lens element EX4 having a convex surface on the image side and a biconcave negative lens element EX5, in that order from the object side.

TABLE 31
SURFACE DATA

| Surf. No. | R | d | N(d) | ν (d) | θ g F |
|---|---|---|---|---|---|
| 1 | 456.906 | 3.168 | 1.80440 | 39.6 | 0.5729 |
| 2 | 144.518 | 0.100 | 1.64310 | 38.8 | 0.5799 |
| 3* | 144.518 | 0.100 | 1.61505 | 26.5 | 0.6153 |
| 4 | 144.518 | 14.430 | 1.48749 | 70.2 | 0.5300 |
| 5 | −3656.683 | 0.200 | | | |
| 6 | 161.860 | 11.059 | 1.43875 | 95.0 | 0.5340 |
| 7 | 4948.334 | 0.200 | | | |
| 8 | 123.760 | 11.450 | 1.43875 | 95.0 | 0.5340 |
| 9 | 581.971 | d9 | | | |
| 10 | −149.581 | 2.000 | 1.74950 | 35.3 | 0.5869 |
| 11 | 78.458 | 0.780 | | | |
| 12 | 130.245 | 6.000 | 1.92286 | 18.9 | 0.6495 |
| 13 | −57.620 | 2.240 | 1.83400 | 37.2 | 0.5776 |
| 14 | 45.962 | d14 | | | |
| 15 | −45.852 | 1.000 | 1.61800 | 63.4 | 0.5441 |
| 16 | 18.400 | 2.804 | 1.80610 | 33.3 | 0.5883 |
| 17 | 39.732 | d17 | | | |
| 18(Diaphragm) | ∞ | 0.600 | | | |
| 19 | ∞ | 1.000 | 1.51633 | 64.1 | 0.5353 |
| 20 | ∞ | 2.200 | | | |
| 21 | 85.714 | 5.275 | 1.43875 | 95.0 | 0.5340 |
| 22 | −84.923 | 0.100 | | | |
| 23 | 51.387 | 4.397 | 1.43875 | 95.0 | 0.5340 |
| 24 | −1122.681 | 0.100 | | | |
| 25 | 49.896 | 6.199 | 1.49700 | 81.6 | 0.5375 |
| 26 | −49.463 | 2.588 | 1.77250 | 49.6 | 0.5520 |
| 27 | 49.938 | 6.185 | | | |
| 28 | 28.740 | 5.198 | 1.61800 | 63.4 | 0.5441 |
| 29 | 677.918 | 0.100 | | | |
| 30 | 32.577 | 1.800 | 1.69680 | 55.5 | 0.5434 |
| 31 | 18.949 | d31 | | | |
| 32 | 25.539 | 3.744 | 1.49700 | 81.6 | 0.5375 |
| 33 | 414.942 | 6.094 | | | |
| 34 | 68.444 | 2.818 | 1.51633 | 64.1 | 0.5353 |
| 35 | −38.918 | 1.200 | 1.60342 | 38.0 | 0.5835 |
| 36 | 37.893 | 10.426 | | | |
| 37 | −96.642 | 2.486 | 1.80518 | 25.4 | 0.6161 |
| 38 | −13.489 | 1.696 | 1.72916 | 54.7 | 0.5444 |
| 39 | 13.047 | 45.277 | | | |
| 40 | ∞ | 3.500 | 1.51633 | 64.1 | 0.5353 |
| 41 | ∞ | — | | | |

Optical Path Difference Function Coefficients for Diffraction
Surface DS

| | | |
|---|---|---|
| NO. 3 | P2 = −1.95080E−02 | P4 = −3.68543E−09 |

Partial Dispersion Ratio for Negative Lens Element 121

θ gF = 0.5729

TABLE 32
VARIOUS LENS SYSTEM DATA
Zoom Ratio: 62.50

| | Short Focal Length | Intermediate | Long Focal Length |
|---|---|---|---|
| | Extremity | Focal Length | Extremity |
| FNO. | 8.0 | 8.0 | 23.8 |
| f | 40.00 | 316.04 | 2500.28 |
| W | 6.3 | 0.8 | 0.1 |
| Y | 4.40 | 4.40 | 4.40 |
| fB | 1.00 | 1.00 | 1.00 |
| L | 389.49 | 389.49 | 389.49 |
| d9 | 50.617 | 132.857 | 147.107 |
| d14 | 84.219 | 7.187 | 60.038 |
| d17 | 76.778 | 71.570 | 4.469 |
| d31 | 8.365 | 8.365 | 8.365 |

Diffraction Surface Incidence Angle (°)

| | | |
|---|---|---|
| 4.37 | 0.89 | 0.06 |

TABLE 33
LENS GROUP DATA

| Lens Group | 1^{st} Surf. | Focal Length |
|---|---|---|
| 1 | 1 | 194.88 |
| 2 | 11 | −40.30 |
| 3 | 16 | −42.14 |
| 4 | 20 | 54.66 |
| 5 | 32 | −36.03 |

The numerical values of each condition for each embodiment are shown in Table 34. In conditions (3), (4), (5), (7), (10), (13) and (14), the numbers in parentheses next to the values corresponding to these conditions indicate the lens numbers of the lens elements that satisfy the respective conditions. In the sixth through eighth numerical embodiments, since the lens arrangement required for condition (11) is different (the third lens group G3 has a positive refractive power), numerical values corresponding to condition (11) cannot be calculated.

TABLE 34

| | Embod. 1 | | Embod. 2 | | Embod. 3 | | Embod. 4 | |
|---|---|---|---|---|---|---|---|---|
| Cond. (1) | 9765.5 | | 9365.1 | | 2188.6 | | 138.6 | |
| Cond. (2) | 0.300 | | 0.231 | | 0.231 | | 0.155 | |
| Cond. (3) | 44.2 | (101) | 51.5 | (111) | 55.4 | (121) | 33.3 | (121) |
| | | | 91.4 | (113) | | | | |
| Cond. (4) | 0.5631 | (101) | 0.5486 | (111) | 0.5484 | (121) | 0.5883 | (121) |
| | | | 0.5342 | (113) | | | | |
| Cond. (5) | 95.0 | (102) | 81.6 | (112) | 95.0 | (122) | 71.3 | (122) |
| | 95.0 | (103) | 95.0 | (114) | 95.0 | (123) | | |
| | | | 95.0 | (115) | 95.0 | (124) | | |
| Cond. (6) | 6.45 | | 2.93 | | 3.97 | | 4.50 | |
| Cond. (7) | 22.8 | (202) | 18.9 | (202) | 18.9 | (202) | 17.5 | (202) |
| Cond. (8) | −0.67 | | −0.75 | | −0.75 | | −0.32 | |
| Cond. (9) | 0.97 | | 0.86 | | 0.86 | | 1.18 | |
| Cond. (10) | 81.6 | (401) | 95.0 | (411) | 95.0 | (411) | 81.6 | (421) |
| | | | 95.0 | (412) | 95.0 | (412) | 95.0 | (422) |
| | | | 81.6 | (413) | 81.6 | (413) | 95.0 | (424) |
| Cond. (11) | 1.75 | | 2.44 | | 2.44 | | 0.93 | |
| Cond. (12) | 4944.9 | | 4532.8 | | 1346.6 | | 147.2 | |
| Cond. (13) | 0.0115 | (102) | 0.0083 | (112) | 0.0115 | (122) | 0.0107 | (122) |
| | 0.0115 | (103) | 0.0115 | (114) | 0.0115 | (123) | | |
| | | | 0.0115 | (115) | 0.0115 | (124) | | |
| Cond. (14) | 0.0030 | (202) | 0.0214 | (202) | 0.0214 | (202) | 0.0316 | (202) |
| Cond. (15) | 1482.2 | | 1047.8 | | 311.3 | | 22.8 | |
| Cond. (16) | −0.77 | | 0.86 | | 0.86 | | 0.28 | |
| | Embod. 5 | | Embod. 6 | | Embod. 7 | | Embod. 8 | |
| Cond. (1) | 143.7 | | 138.9 | | 1151.9 | | 1401.1 | |
| Cond. (2) | 0.153 | | 0.208 | | 0.308 | | 0.302 | |
| Cond. (3) | 39.6 | (135) | 91.4 | (144) | 46.6 | (151) | 40.9 | (151) |
| Cond. (4) | 0.5729 | (135) | 0.5342 | (144) | 0.5573 | (151) | 0.5701 | (151) |
| Cond. (5) | 95.0 | (133) | 95.0 | (143) | 95.0 | (152) | 81.6 | (152) |
| | 95.0 | (134) | | | 95.0 | (153) | 81.6 | (153) |
| Cond. (6) | 3.12 | | 2.98 | | 5.17 | | 5.13 | |
| Cond. (7) | 18.9 | (202) | 22.8 | (214) | 18.9 | (223) | 17.5 | (223) |
| Cond. (8) | −0.23 | | −0.24 | | −0.25 | | −0.25 | |
| Cond. (9) | 1.12 | | 1.15 | | 0.56 | | 0.65 | |
| Cond. (10) | 81.6 | (431) | 95.0 | (442) | 71.3 | (501) | 71.3 | (511) |
| | 81.6 | (432) | 81.6 | (444) | | | | |
| | 95.0 | (433) | | | | | | |
| | 95.0 | (435) | | | | | | |
| Cond. (11) | 0.95 | | — | | — | | — | |
| Cond. (12) | 183.9 | | 148.5 | | 642.7 | | 692.3 | |
| Cond. (13) | 0.0115 | (133) | 0.0334 | (142) | 0.0115 | (152) | 0.0083 | (152) |
| | 0.0115 | (134) | 0.0115 | (143) | 0.0115 | (153) | 0.0083 | (153) |
| Cond. (14) | 0.0214 | (202) | 0.0030 | (214) | 0.0214 | (223) | 0.0316 | (223) |

| | | | | |
|---|---|---|---|---|
| Cond. (15) | 28.1 | 30.9 | 197.8 | 208.9 |
| Cond. (16) | 0.08 | 1.74 | 1.42 | 1.68 |

| | Embod. 9 | | Embod. 10 | |
|---|---|---|---|---|
| Cond. (1) | 238.2 | | 301.8 | |
| Cond. (2) | 0.155 | | 0.156 | |
| Cond. (3) | 37.3 | (121) | 39.6 | (121) |
| Cond. (4) | 0.5789 | (121) | 0.5729 | (121) |
| Cond. (5) | 81.6 | (122) | 95.0 | (123) |
| | 81.6 | (123) | 95.0 | (124) |
| Cond. (6) | 4.50 | | 4.79 | |
| Cond. (7) | 17.5 | (202) | 18.9 | (202) |
| Cond. (8) | −0.32 | | −0.25 | |
| Cond. (9) | 1.18 | | 0.99 | |
| Cond. (10) | 81.6 | (421) | 95.0 | (411) |
| | 95.0 | (422) | 95.0 | (412) |
| | 95.0 | (424) | 81.6 | (413) |
| Cond. (11) | 0.93 | | 0.96 | |
| Cond. (12) | 195.0 | | 223.8 | |
| Cond. (13) | 0.0083 | (122) | 0.0115 | (123) |
| | 0.0083 | (123) | 0.0115 | (124) |
| Cond. (14) | 0.0316 | (202) | 0.0214 | (202) |

| | | |
|---|---|---|
| Cond. (15) | 30.2 | 34.9 |
| Cond. (16) | 0.28 | 0.31 |

As can be understood from Table 34, the first through fifth, ninth and tenth numerical embodiments satisfy conditions (1) through (14), and the sixth through eighth numerical embodiments satisfy conditions (1) through (10) and conditions (12) through (14). As can be understood from the various aberration diagrams, the various aberrations are relatively well corrected.

The technical scope of the present invention would not be evaded even if a lens element or lens group which has, in effect, no optical power were to be added to a zoom lens system that is included in the technical scope of the present invention.

### INDUSTRIAL APPLICABILITY

The zoom lens system of the present invention are suitable for use in, for example, a day-and-night surveillance lens system (day-and-night lens).

### REFERENCE SIGNS LIST

G1 Positive first lens group
G2 Negative second lens group
G3 Negative third lens group
G4 Positive fourth lens group (stationary lens group)
G1′ Positive first lens group
G2′ Negative second lens group
G3′ Positive third lens group
G4′ Negative fourth lens group (stationary lens group)
G1″ Positive first lens group
G2″ Negative second lens group
G3″ Positive third lens group
G4″ Negative fourth lens group
G5″ Positive fifth lens group (stationary lens group)
101, 102 Cemented lens having diffraction surface
113, 114 Cemented lens having diffraction surface
121, 122 Cemented lens having diffraction surface
131, 132 Cemented lens having diffraction surface
143, 144 Cemented lens having diffraction surface
151, 152 Cemented lens having diffraction surface
DS Diffraction surface (diffraction lens surface)
ND ND Filter
S Diaphragm
I Imaging surface

1. A zoom lens system comprising at least a positive first lens group and a negative second lens group, in that order from the object side, wherein a distance between said first lens group and said second lens group increases while zooming from the short focal length extremity to the long focal length extremity,
wherein said first lens group includes at least one cemented lens,
wherein a diffraction surface having a rotationally symmetric shape with respect to the optical axis and satisfying the following condition (1) is formed on a cemented surface of at least one of said cemented lens, and
wherein the following condition (2) is satisfied:
130<|fD/RD|<10,000(fD>0) (1),
and
0.15<f1/fT<0.35 (2),
wherein
fD designates the focal length of said diffraction surface that is formed on said cemented surface of said cemented lens, provided within said first lens group,
fD=−1/(2×P2×λ0),
P2 designates a secondary coefficient of an optical path difference function for calculating an optical path length addition amount of said diffraction surface that is formed on said cemented surface of said cemented lens, provided within said first lens group,
λ0 designates the d-line (587.56 nm),
RD designates the radius of curvature of the substrate surface having said diffraction surface that is formed on said cemented surface of said cemented lens, provided within said first lens group,
f1 designates the focal length of said first lens group, and
fT designates the focal length of the entire lens system at the long focal length extremity.

2. The zoom lens system according to claim 1, wherein said first lens group comprises at least one negative lens element and the following conditions (3) and (4) are satisfied:
νn1>33 (3),
and
θgFn1<0.59 (4),
wherein
νn1 designates the Abbe number at the d-line of said at least one negative lens element of negative lens elements that are provided in said first lens group, and
θgFn1 designates the partial dispersion ratio of said at least one negative lens element of negative lens elements that are provided in said first lens group.

3. (canceled)

4. (canceled)

5. (canceled)

6. The zoom lens system according to claim 1, wherein the following condition (6) is satisfied:
2.9<f1/1gD<6.5 (6),
wherein
f1 designates the focal length of said first lens group, and
1gD designates the distance from the surface closest to the object side on said first lens group to the surface closest to the image side on said first lens group.

7. The zoom lens system according to claim 1, wherein each lens element of said cemented lens that is provided within said first lens group comprises a resin material on an opposing substrate glass, wherein a diffraction surface is formed on a boundary surface between said resin materials.

8. The zoom lens system according to claim 1, wherein said second lens group comprises at least one positive lens element, and wherein the following condition (7) is satisfied:
νp2<23 (7),
wherein
νp2 designates the Abbe number at the d-line of said at least one positive lens element provided within said second lens group.

9. The zoom lens system according to claim 1, wherein the following condition (8) is satisfied:
−0.8<f2/(fW×fT)^{1/2}<−0.2 (8),
wherein
f2 designates the focal length of said second lens group,
fW designates the focal length of the entire lens system at the short focal length extremity, and
fT designates the focal length of the entire lens system at the long focal length extremity.

10. The zoom lens system according to claim 1, further comprising a positive or negative stationary lens group, at a position closest to the image side, which is stationary relative to the imaging plane during zooming from the short focal length extremity to the long focal length extremity, wherein the following condition (9) is satisfied:

|mL|<1.2 (9),
wherein
mL designates the lateral magnification of said stationary lens group that is positioned closest to the image side.

11. The zoom lens system according to claim 1, further comprising a positive or negative stationary lens group, at a position closest to the image side, which is stationary relative to the imaging plane during zooming from the short focal length extremity to the long focal length extremity, wherein said stationary lens group includes at least one positive lens element, and wherein the following condition (10) is satisfied:
νpL>71 (10),
wherein
νpL designates the Abbe number at the d-line of said at least one positive lens element provided within said stationary lens group that is positioned closest to the image side.

12. The zoom lens system according to claim 1, further comprising a negative third lens group, behind said second lens group, which moves during zooming from the short focal length extremity to the long focal length extremity, wherein the following condition (11) is satisfied:
0.9<f2/f3<2.5 (11),
wherein
f2 designates the focal length of said second lens group, and
f3 designates the focal length of said third lens group.

13. (canceled)

14. (canceled)

15. A zoom lens system comprising at least a positive first lens group and a negative second lens group, in that order from the object side, wherein, while zooming from the short focal length extremity to the long focal length extremity, said first lens group remains stationary relative to the imaging plane, and a distance between said first lens group and said second lens group increases by said second lens group moving toward the image side,
wherein said first lens group includes at least one cemented lens,
wherein a diffraction surface having a rotationally symmetric shape with respect to the optical axis and satisfying the following condition (1) is formed on a cemented surface of at least one of said cemented lens,
wherein said first lens group includes at least one positive lens element, and
wherein the following condition (5) is satisfied:
130<|fD/RD|<10,000(fD>0) (1),
and
νp1>71 (5),
wherein
fD designates the focal length of said diffraction surface that is formed on said cemented surface of said cemented lens, provided within said first lens group,
fD=−1/(2×P2×λ0),
P2 designates a secondary coefficient of an optical path difference function for calculating an optical path length addition amount of said diffraction surface that is formed on said cemented surface of said cemented lens, provided within said first lens group,
λ0 designates the d-line (587.56 nm),
RD designates the radius of curvature of the substrate surface having said diffraction surface that is formed on said cemented surface of said cemented lens, provided within said first lens group, and
νp1 designates the Abbe number at the d-line of said at least one positive lens element provided within said first lens group.

16. (canceled)

17. (canceled)

18. A zoom lens system comprising at least a positive first lens group and a negative second lens group, in that order from the object side, wherein, while zooming from the short focal length extremity to the long focal length extremity, said first lens group remains stationary relative to the imaging plane, and a distance between said first lens group and said second lens group increases by said second lens group moving toward the image side,
wherein said first lens group includes at least one cemented lens,
wherein a diffraction surface having a rotationally symmetric shape with respect to the optical axis and satisfying the following condition (1) is formed on a cemented surface of at least one of said cemented lens, and
wherein an angle between each principal ray, which is incident on the diffraction surface formed on said cemented surface of said cemented lens of said first lens group, and the optical axis is 13° or less:
130<|fD/RD|<10,000(fD>0) (1),
wherein
fD designates the focal length of said diffraction surface that is formed on said cemented surface of said cemented lens, provided within said first lens group,
fD=−1/(2×P2×λ0),
P2 designates a secondary coefficient of an optical path difference function for calculating, an optical path length addition amount of said diffraction surface that is formed on said cemented surface of said cemented lens, provided within said first lens group,
λ0 designates the d-line (587.56 nm), and
RD designates the radius of curvature of the substrate surface having said diffraction surface that is formed on said cemented surface of said cemented lens, provided within said first lens group.

19. A zoom lens system comprising at least a positive first lens group and a negative second lens group, in that order from the object side, wherein a distance between said first lens group and said second lens group increases while zooming from the short focal length extremity to the long focal length extremity,
wherein said first lens group includes at least one cemented lens,
wherein a diffraction surface having a rotationally symmetric shape with respect to the optical axis and satisfying the following condition (12) is formed on a cemented surface of at least one of said cemented lens, and
wherein the following condition (2) is satisfied:
0.15<f1/fT<0.35 (2),
and
130<fD/f1(fD>0) (12),
wherein
f1 designates the focal length of said first lens group,
fT designates the focal length of the entire lens system at the long focal length extremity,
fD designates the focal length of said diffraction surface that is formed on said cemented surface of said cemented lens, provided within said first lens group,
fD=−1/(2×P2×λ0),
P2 designates a secondary coefficient of an optical path difference function for calculating an optical path length addition amount of said diffraction surface that is formed on said cemented surface of said cemented lens, provided within said first lens group, and
λ0 designates the d-line (587.56 nm).

20. (canceled)

21. (canceled)

22. (canceled)

23. A zoom lens system comprising at least a positive first lens group and a negative second lens group, in that order from the object side, wherein, while zooming from the short focal length extremity to the long focal length extremity, said first lens group remains stationary relative to the imaging plane, and a distance between said first lens group and said second lens group increases by said second lens group moving toward the image side,
wherein said first lens group includes at least one cemented lens,
wherein a diffraction surface having a rotationally symmetric shape with respect to the optical axis and satisfying the following condition (1) is formed on a cemented surface of at least one of said cemented lens,
wherein said first lens group includes at least one negative lens element, and
wherein the following conditions (3) and (4) are satisfied:
130<|fD/RD|<10,000(fD>0) (1),
νn1>33 (3),
and
θgFn1<0.59 (4),
wherein
fD designates the focal length of said diffraction surface that is formed on said cemented surface of said cemented lens, provided within said first lens group,
fD=−1/(2×P2×λ0),
P2 designates a secondary coefficient of an optical path difference function for calculating an optical path length addition amount of said diffraction surface that is formed on said cemented surface of said cemented lens, provided within said first lens group,
λ0 designates the d-line (587.56 nm),
RD designates the radius of curvature of the substrate surface having said diffraction surface that is formed on said cemented surface of said cemented lens, provided within said first lens group,
νn1 designates the Abbe number at the d-line of said at least one negative lens element of negative lens elements that are provided in said first lens group, and
θgFn1 designates the partial dispersion ratio of said at least one negative lens element of negative lens elements that are provided in said first lens group.

24. The zoom lens system according to claim 23, wherein the following condition (6) is satisfied:
2.9<f1/1gD<6.5 (6),
wherein
f1 designates the focal length of said first lens group, and
1gD designates the distance from the surface closest to the object side on said first lens group to the surface closest to the image side on said first lens group.

25. The zoom lens system according to claim 23, wherein each lens element of said cemented lens that is provided within said first lens group comprises a resin material on an opposing substrate glass, wherein a diffraction surface is formed on a boundary surface between said resin materials.

26. The zoom lens system according to claim 23, wherein said second lens group comprises at least one positive lens element, and wherein the following condition (7) is satisfied:
νp2<23 (7),
wherein
νp2 designates the Abbe number at the d-line of said at least one positive lens element provided within said second lens group.

27. The zoom lens system according to claim 23, wherein the following condition (8) is satisfied:
−0.8<f2/(fW×fT)^{1/2}<−0.2 (8),
wherein
f2 designates the focal length of said second lens group,
fW designates the focal length of the entire lens system at the short focal length extremity, and
fT designates the focal length of the entire lens system at the long focal length extremity.

28. The zoom lens system according to claim 23, further comprising a positive or negative stationary lens group, at a position closest to the image side, which is stationary relative to the imaging plane during zooming from the short focal length extremity to the long focal length extremity, wherein the following condition (9) is satisfied:

|mL|<1.2 (9),
wherein
mL designates the lateral magnification of said stationary lens group that is positioned closest to the image side.

29. The zoom lens system according to claim 23, further comprising a positive or negative stationary lens group, at a position closest to the image side, which is stationary relative to the imaging plane during zooming from the short focal length extremity to the long focal length extremity, wherein said stationary lens group includes at least one positive lens element, and wherein the following condition (10) is satisfied:
νpL>71 (10),
wherein
νpL designates the Abbe number at the d-line of said at least one positive lens element provided within said stationary lens group that is positioned closest to the image side.

30. The zoom lens system according to claim 23, further comprising a negative third lens group, behind said second lens group, which moves during zooming from the short focal length extremity to the long focal length extremity, wherein the following condition (11) is satisfied:
0.9<f2/f3<2.5 (11),
wherein
f2 designates the focal length of said second lens group, and
f3 designates the focal length of said third lens group.
